(19) United States
(12) Patent Application Publication
(10) Pub. No.: US 2019/0092913 A1
(43) Pub. Date: Mar. 28, 2019

(54) POLYIMIDE FILM, METHOD FOR PRODUCING POLYIMIDE FILM, AND POLYIMIDE PRECURSOR RESIN COMPOSITION

(71) Applicant: DAI NIPPON PRINTING CO., LTD., Tokyo-to (JP)

(72) Inventors: Katsuya SAKAYORI, Tokyo (JP); Yoshihiro KOBAYASHI, Tokyo (JP); Keisuke WAKITA, Tokyo (JP); Ayako FURUSE, Tokyo (JP); Koudai OKADA, Tokyo (JP)

(73) Assignee: DAI NIPPON PRINTING CO., LTD., Tokyo-to (JP)

(21) Appl. No.: 16/081,751

(22) PCT Filed: Feb. 24, 2017
(86) PCT No.: PCT/JP2017/007114

§ 371 Date: Nov. 5, 2018

(30) Foreign Application Priority Data
Mar. 3, 2016 (JP) 2016-041542

(51) Int. Cl. C08J 5/18; C08L 79/08; C08K 3/26

(52) U.S. Cl. CPC C08J 5/18; C08L 79/08; C08K 3/26; C08K 2003/267; C08J 2379/08; C08K 2003/265; C08L 2203/16

(57) ABSTRACT

A resin film has improved rigidity and flex resistance, and reduced optical distortion. A polyimide film has a polyimide containing an aromatic ring, and inorganic particles having a smaller refractive index in a major axis direction than an average refractive index in a direction perpendicular to the major axis direction, wherein, when the polyimide film is monotonically heated from 25° C. at 10° C./min, a size shrinkage ratio represented by the following formula in at least one direction is 0.1% or more at at least one temperature in a range of from 250° C. to 400° C.: size shrinkage ratio (%)=[{(size at 25° C.)−(size after heating)}/(size at 25° C.)]×100; wherein a birefringence index in a thickness direction is 0.020 or less at a wavelength of 590 nm; and wherein a total light transmittance measured in accordance with JIS K7361-1 is 80% or more at a thickness of 10 μm.

### TECHNICAL FIELD

The present invention relates to a polyimide film, a method for producing a polyimide film, and a polyimide precursor resin composition.

### BACKGROUND ART

A thin glass plate has excellent rigidity, heat resistance, etc. On the other hand, it cannot be easily bent, is easily broken when dropped, and has a problem with processability. Also, it has a problem in that it is heavy compared to plastic products. Due to these reasons, recently, glass products have been replaced with resin products such as a resin substrate and a resin film, from the viewpoint of processability and weight reduction, and studies on resin products that can substitute for glass products have been conducted.

For example, a rapid progress of electronics such as liquid crystal displays, organic EL displays and touch panels, has created a demand for thinner, lighter and flexible devices. In these devices, conventionally, various electron elements such as a thin transistor and a transparent electrode are formed on a thin glass plate. By changing the thin glass plate to a resin film, a flexible, thin, light panel can be obtained.

For example, Patent Literature 1 describes that a transparent resin substrate such as a polyethylene terephthalate (PET) film is used as a substitute for the thin glass plate of a touch panel.

Patent Literature 2 describes a transparent multilayer synthetic resin sheet for a transparent conductive film base material, the sheet including a transparent hard resin layer having a specific bending elastic modulus, and polycarbonate resin layers provided on both surfaces of the transparent hard resin layer, in order to improve the rigidity and impact resistance of a polycarbonate sheet.

Patent Literature 3 describes a method for manufacturing a retardation film comprising polyimide.

### CITATION LIST

Patent Literature 1: Japanese Patent Application Laid-Open (JP-A) No. 2008-158911

Patent Literature 2: JP-A No. 2011-201093

Patent Literature 3: JP-A No. 2006-3715

### SUMMARY OF INVENTION

### Technical Problem

However, conventional resin films and the resin films as described in Patent Literatures 1 and 2 are still insufficient in heat resistance, rigidity and flex resistance, and there is no resin film that is excellent in both rigidity and flex resistance. The retardation film as described in Patent Literature 3 is basically a film with large optical distortion, and it cannot be used as a substitute for a glass with small optical distortion, therefore. Also, the retardation film as disclosed in Patent Literature 3 is insufficient in rigidity.

Due to the above reasons, there is a demand for a resin film with improved rigidity and flex resistance and reduced optical distortion.

The present invention was achieved in light of the above circumstance. An object of the present invention is to provide a resin film with improved rigidity and flex resistance and reduced optical distortion.

Another object of the present invention is to provide a method for producing the resin film, a polyimide precursor resin composition suitable for the production of the resin film.

### Solution to Problem

As a resin film of a first embodiment of the present invention, there is provided a polyimide film comprising a polyimide containing an aromatic ring, and inorganic particles having a smaller refractive index in a major axis direction than an average refractive index in a direction perpendicular to the major axis direction, wherein, when the polyimide film is monotonically heated from 25° C. at 10° C./min, a size shrinkage ratio represented by the following formula in at least one direction is 0.1% or more at at least one temperature in a range of from 250° C. to 400° C.: size shrinkage ratio (%)=[{(size at 25° C.)−(size after heating)}/(size at 25° C.)]×100;

wherein a birefringence index in a thickness direction is 0.020 or less at a wavelength of 590 nm; and

wherein a total light transmittance measured in accordance with JIS K7361-1 is 80% or more at a thickness of 10 μm.

As a resin film of a second embodiment of the present invention, there is provided a polyimide film comprising a polyimide containing an aromatic ring, and inorganic particles having a smaller refractive index in a major axis direction than an average refractive index in a direction perpendicular to the major axis direction, wherein a linear thermal expansion coefficient is −10 ppm/° C. or more and 40 ppm/° C. or less; wherein a birefringence index in a thickness direction is 0.020 or less at a wavelength of 590 nm; wherein a total light transmittance measured in accordance with JIS K7361-1 is 80% or more at a thickness of 10 μm; and wherein the polyimide has at least one structure selected from the group consisting of structures represented by the following general formulae (1) and (3):

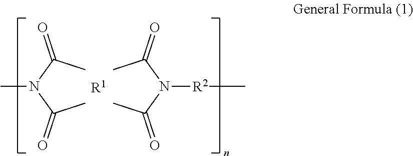

where R¹ represents a tetravalent group that is a tetracarboxylic acid residue; R² represents at least one divalent group selected from the group consisting of a trans-cyclohexanediamine residue, a trans-1,4-bismethylenecyclohexane diamine residue, a 4,4′-diaminodiphenylsulfone residue, a 3,4′-diaminodiphenylsulfone residue, and a divalent group represented by the following general formula (2); and n represents a number of repeating units and is 1 or more:

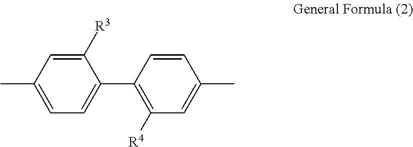

where R³ and R⁴ each independently represent a hydrogen atom, an alkyl group or a perfluoroalkyl group,

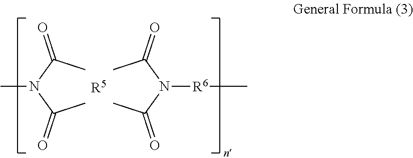

where R⁵ represents at least one tetravalent group selected from the group consisting of a cyclohexanetetracarboxylic acid residue, a cyclopentanetetracarboxylic acid residue, a dicyclohexane-3,4,3′,4′-tetracarboxylic acid residue, and a 4,4′-(hexafluoroisopropylidene)diphthalic acid residue; R⁶ represents a divalent group that is a diamine residue; and n′ represents a number of repeating units and is 1 or more.

A method for producing the polyimide film of the first embodiment of the present invention, is a method for producing a polyimide film, comprising steps of:

preparing a polyimide precursor resin composition having a water content of 1000 ppm or less and comprising a polyimide precursor containing an aromatic ring, inorganic particles having a smaller refractive index in a major axis direction than an average refractive index in a direction perpendicular to the major axis direction, and an organic solvent,

forming a polyimide precursor resin coating film by applying the polyimide precursor resin composition to a support,

imidizing the polyimide precursor by heating, and

stretching at least one of the polyimide precursor resin coating film and an imidized coating film obtained by imidizing the polyimide precursor resin coating film,

wherein the polyimide film comprises a polyimide and inorganic particles having a smaller refractive index in a major axis direction than an average refractive index in a direction perpendicular to the major axis direction;

wherein, when the polyimide film is monotonically heated from 25° C. at 10° C./min, a size shrinkage ratio represented by the following formula in at least one direction is 0.1% or more at at least one temperature in a range of from 250° C. to 400° C.: size shrinkage ratio (%)=[{(size at 25° C.)−(size after heating)}/(size at 25° C.)]×100;

wherein a birefringence index in a thickness direction is 0.020 or less at a wavelength of 590 nm; and

wherein a total light transmittance measured in accordance with JIS K7361-1 is 80% or more at a thickness of 10 μm.

For the polyimide film of the first embodiment of the present invention and the method for producing the polyimide film, from the viewpoint of light transmittability, heat resistance and rigidity, it is preferable that the polyimide has at least one structure selected from the group consisting of structures represented by the general formulae (1) and (3).

For the polyimide film of the first embodiment of the present invention, the method for producing the polyimide film, and the polyimide film of the second embodiment, from the viewpoint of light transmittability, heat resistance and rigidity, it is preferable that 70% or more of hydrogen atoms bound to carbon atoms contained in the polyimide, are hydrogen atoms directly bound to the aromatic ring.

For the polyimide film of the first embodiment of the present invention, the method for producing the polyimide film, and the polyimide film of the second embodiment, from the viewpoint of reducing optical distortion easily, it is preferable that the inorganic particles are at least one kind of particles selected from the group consisting of calcium carbonate, magnesium carbonate, zirconium carbonate, strontium carbonate, cobalt carbonate and manganese carbonate.

Also in the present invention, there is provided a polyimide precursor resin composition having a water content of 1000 ppm or less and comprising a polyimide precursor containing an aromatic ring, inorganic particles having a smaller refractive index in a major axis direction than an average refractive index in a direction perpendicular to the major axis direction, and an organic solvent.

Also in the present invention, there is provided a polyimide precursor resin composition comprising a polyimide precursor containing an aromatic ring, inorganic particles having a smaller refractive index in a major axis direction than an average refractive index in a direction perpendicular to the major axis direction, and an organic solvent containing a nitrogen atom.

For the polyimide precursor resin composition of the present invention, from the viewpoint of light transmittability, heat resistance and rigidity, it is preferable that the polyimide precursor has at least one structure selected from the group consisting of structures represented by the following general formulae (1′) and (3′):

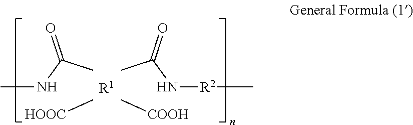

where R¹ represents a tetravalent group that is a tetracarboxylic acid residue; R² represents at least one divalent group selected from the group consisting of a trans-cyclohexanediamine residue, a trans-1,4-bismethylenecyclohexane diamine residue, a 4,4′-diaminodiphenylsulfone residue, a 3,4′-diaminodiphenylsulfone residue, and a divalent group represented by the following general formula (2); and n represents a number of repeating units and is 1 or more:

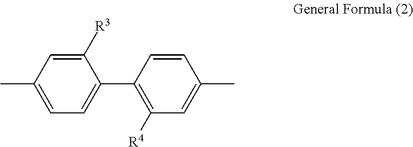

where R³ and R⁴ each independently represent a hydrogen atom, an alkyl group or a perfluoroalkyl group, and

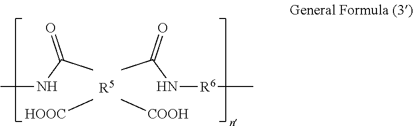

where R⁵ represents at least one tetravalent group selected from the group consisting of a cyclohexanetetracarboxylic acid residue, a cyclopentanetetracarboxylic acid residue, a dicyclohexane-3,4,3′,4′-tetracarboxylic acid residue, and a 4,4′-(hexafluoroisopropylidene)diphthalic acid residue; R⁶ represents a divalent group that is a diamine residue; and n′ represents a number of repeating units and is 1 or more.

For the polyimide precursor resin composition of the present invention, from the viewpoint of light transmittability, heat resistance and rigidity, it is preferable that 70% or more of hydrogen atoms bound to carbon atoms contained in the polyimide precursor, are hydrogen atoms directly bound to the aromatic ring.

For the polyimide precursor resin composition of the present invention, from the viewpoint of reducing optical distortion easily, it is preferable that the inorganic particles are at least one kind of particles selected from the group consisting of calcium carbonate, magnesium carbonate, zirconium carbonate, strontium carbonate, cobalt carbonate and manganese carbonate.

### Advantageous Effects of Invention

According to the present invention, a resin film with improved rigidity and flex resistance and reduced optical distortion, can be provided.

According to the present invention, a method for producing the resin film and a polyimide precursor resin composition suitable for the production of the resin film, can be provided.

### DESCRIPTION OF EMBODIMENTS

### I. Polyimide Film

The polyimide film of the first embodiment of the present invention is a polyimide film comprising a polyimide containing an aromatic ring, and inorganic particles having a smaller refractive index in a major axis direction than an average refractive index in a direction perpendicular to the major axis direction,

wherein, when the polyimide film is monotonically heated from 25° C. at 10° C./min, a size shrinkage ratio represented by the following formula in at least one direction is 0.1% or more at at least one temperature in a range of from 250° C. to 400° C.: size shrinkage ratio (%)=[{(size at 25° C.)−(size after heating)}/(size at 25° C.)]×100;

wherein a birefringence index in a thickness direction is 0.020 or less at a wavelength of 590 nm; and

wherein a total light transmittance measured in accordance with JIS K7361-1 is 80% or more at a thickness of 10 μm.

The size shrinkage ratio may be shown in at least one direction of the polyimide film. In general, size shrinkage is observed in the in-plane direction of polyimide films. Since the size shrinkage ratio of the polyimide film of the first embodiment is 0.1% or more, it is clear that the polyimide film is a stretched film.

The size shrinkage ratio is preferably 0.3% or more. On the other hand, when the size shrinkage ratio is too large, wrinkles may be produced by heating. Therefore, the size shrinkage ratio is preferably 60% or less, and more preferably 40% or less.

In the present invention, the size shrinkage ratio can be obtained by increasing the temperature from 25° C. to 400° C. at a temperature increase rate of 10° C./min in a nitrogen atmosphere, using a thermomechanical analyzer (TMA). A general polyimide film having a positive linear thermal expansion coefficient monotonically increases in size, along with temperature increase, and the size rapidly increases at a softening point. Meanwhile, along with temperature increase, the size of a polyimide film subjected to imidization and then stretching, shrinks at around a temperature corresponding to the temperature at which the stretching was carried out. The size shrinkage ratio is obtained by the above formula, with the use of a sample size when the polyimide film shrunk at at least one temperature in a range of from 250° C. to 400° C. and a sample size at 25° C.

The polyimide film may satisfy the size shrinkage ratio at at least one temperature in a range of from 250° C. to 400° C.

Since the size shrinkage ratio is represented as a percentage, it is obtained as a positive value when the sample size at a temperature in a range of from 250° C. to 400° C. is smaller than the sample size at 25° C. In general, the local maximum of the size shrinkage ratio may not always be at at least one temperature in a range of from 250° C. to 400° C. However, the size shrinkage ratio is calculated not only when taking the local maximum, but also simply from the ratio between the size at each temperature and the size at 25° C.

For example, in the case of measuring a highly hygroscopic film, size shrinkage may be observed at around 100° C., which is derived from water evaporation. To be distinguished from them, the polyimide resin composition of the present invention is characterized by showing shrinking behavior at at least one temperature in a range of from 250° C. to 400° C. It is particularly preferable that the polyimide film satisfies the above size shrinkage ratio at at least one temperature in a range of from 280° C. to 400° C.

The birefringence index in the thickness direction is 0.020 or less at a wavelength of 590 nm. Due to having such a birefringence index, the polyimide film of the first embodiment has reduced optical distortion. The birefringence index at a wavelength of 590 nm is preferably smaller. It is preferably 0.015 or less, more preferably 0.010 or less, and still more preferably less than 0.008.

For the polyimide film of the present invention, the birefringence index in the thickness direction of at a wavelength of 590 nm, can be obtained as follows.

First, using a retardation measuring device such as “KOBRA-WR” (product name, manufactured by Oji Scientific Instruments), the thickness-direction retardation value (Rth) of the polyimide film is measured at 23° C. by a light with a wavelength of 590 nm. The thickness-direction retardation value (Rth) is obtained as follows: the retardation value of incidence at an angle of 0 degrees and the retardation value of incidence at an oblique angle of degrees are measured, and the thickness-direction retardation value Rth is calculated from the retardation values. The retardation value of incidence at an oblique angle of 40 degrees is measured by making a light with a wavelength of 590 nm incident to a retardation film from a direction inclined at an angle of 40 degrees from the normal line of the retardation film.

For the polyimide film of the present invention, the birefringence index in the thickness direction can be obtained by plugging the obtained Rth in the following formula: Rth/d. In this formula, d represents the thickness (nm) of the polyimide film.

The thickness-direction retardation value can be represented as follows:

Rth(nm)={(nx+ny)/2−nz}×d

where nx is the refractive index in the slow axis direction in the in-plane direction of the film (the direction in which the refractive index in the in-plane direction of the film is the maximized); ny is the refractive index in the fast axis direction in the in-plane direction of the film (the direction in which the refractive index in the in-plane direction of the film is minimized); and nz is the thickness-direction refractive index of the film.

The total light transmittance measured in accordance with JIS K7361-1 is 80% or more at a thickness of 10 μm. Due to the high transmittance, the polyimide film obtains excellent transparency and can serve as a substitute material for glass. The total light transmittance measured in accordance with JIS K7361-1 is more preferably 83% or more, and still more preferably 88% or more, at a thickness of 10 μm.

The total light transmittance measured in accordance with JIS K7361-1, can be measured by a haze meter (such as “HM150” manufactured by Murakami Color Research Laboratory Co., Ltd.), for example. When the thickness is not 10 μm, a corresponding value can be obtained by the Beer-Lambert law and used as the total light transmittance.

The polyimide film of the second embodiment of the present invention is a polyimide film comprising a polyimide and inorganic particles having a smaller refractive index in a major axis direction than an average refractive index in a direction perpendicular to the major axis direction, wherein a linear thermal expansion coefficient is −10 ppm/° C. or more and 40 ppm/° C. or less; wherein a birefringence index in a thickness direction is 0.020 or less at a wavelength of 590 nm; wherein a total light transmittance measured in accordance with JIS K7361-1 is 80% or more at a thickness of 10 μm; and wherein the polyimide has at least one structure selected from the group consisting of structures represented by the following general formulae (1) and (3):

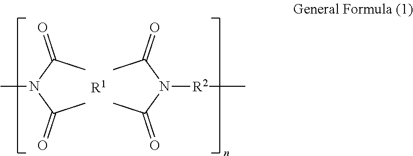

where R¹ represents a tetravalent group that is a tetracarboxylic acid residue; R² represents at least one divalent group selected from the group consisting of a trans-cyclohexanediamine residue, a trans-1,4-bismethylenecyclohexane diamine residue, a 4,4′-diaminodiphenylsulfone residue, a 3,4′-diaminodiphenylsulfone residue, and a divalent group represented by the following general formula (2); and n represents a number of repeating units and is 1 or more:

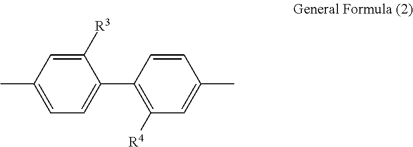

where R³ and R⁴ each independently represent a hydrogen atom, an alkyl group or a perfluoroalkyl group, and

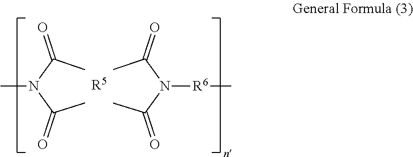

where R⁵ represents at least one tetravalent group selected from the group consisting of a cyclohexanetetracarboxylic acid residue, a cyclopentanetetracarboxylic acid residue, a dicyclohexane-3,4,3′,4′-tetracarboxylic acid residue, and a 4,4′-(hexafluoroisopropylidene)diphthalic acid residue; R⁶ represents a divalent group that is a diamine residue; and n′ represents a number of repeating units and is 1 or more.

Since the linear thermal expansion coefficient is −10 ppm/° C. or more and 40 ppm/° C. or less, it is shown that the linear thermal expansion coefficient is small, that is, a rigid chemical structure is oriented. The linear thermal expansion coefficient is more preferably 20 ppm/° C. or less, and still more preferably 10 ppm/° C. or less.

In the present invention, the linear thermal expansion coefficient is measured by a thermomechanical analyzer (such as “TMA-60” manufactured by Shimadzu Corporation) at a temperature increase rate of 10° C./min and a tensile load of 9 g/0.15 mm² so that the same load is applied per cross-sectional area of an evaluation sample, and the linear thermal expansion coefficient is a value obtained by calculating a linear thermal expansion coefficient from results at 100° C. to 150° C. For example, the linear thermal expansion coefficient can be measured in the conditions of a sample width of 5 mm and a chuck distance of 15 mm.

The birefringence index and total light transmittance of the polyimide film of the second embodiment are the same as those of the polyimide film of the first embodiment.

According to the first embodiment of the present invention, the polyimide film comprises the polyimide containing an aromatic ring, and the inorganic particles having the specific polarization axis. Moreover, the polyimide film has the above-mentioned specific size shrinkage ratio, birefringence index and total light transmittance. Therefore, a resin film with improved rigidity and flex resistance and reduced optical distortion can be provided.

According to the second embodiment of the present invention, the polyimide film comprises the polyimide containing an aromatic ring and the specific structure, and the inorganic particles having the specific polarization axis. Moreover, the polyimide film has the above-mentioned specific linear thermal expansion coefficient, birefringence index and total light transmittance. Therefore, a resin film with improved rigidity and flex resistance and reduced optical distortion can be provided.

The reason is as described above. Also, it is presumed as follows.

Among resins, the inventors of the present invention focused attention on polyimides. Due to the chemical structures, polyimides are known to have excellent heat resistance. Polyimides containing an aromatic ring have excellent heat resistance, and some of them show a linear thermal expansion coefficient that is as small as those of metal, ceramics and glass, due to their rigid frameworks. For polyimide films, it is known that the arrangement of molecular chains inside thereof forms a certain ordered structure. Therefore, they have excellent flex resistance and are increasingly used in a flexible printed circuit board, etc. However, as a result of research, the inventors of the present invention found that a polyimide with large flex resistance and rigidity and small linear thermal expansion, has a rigid chemical structure and, as a result, a polyimide film with high rigidity causes large optical distortion (birefringence). Meanwhile, a polyimide film with small birefringence has small rigidity, and it was found that there is a trade-off relationship between the rigidity and birefringence of a polyimide film. The reason is presumed as follows. A film of polyimide with a rigid framework and high orientation has high rigidity; however, it has large birefringence since the rigid chemical structure is oriented. Meanwhile, for a film of polyimide with a low-linearity framework, since low-linearity chemical structures are randomly arranged, polarization component are isotropically present. Therefore, although the birefringence of the polyimide film is small, the rigidity is low.

Meanwhile, according to the present invention, the rigidity of the polyimide film is improved by forming the polyimide film into a stretched film so that the molecular chain of the polyimide containing an aromatic ring is densely oriented (the first embodiment), or the rigidity of the polyimide film is improved by selecting a polyimide containing an aromatic ring and, due to having the specific rigid chemical structure, having a low linear thermal expansion coefficient and high orientation (the second embodiment). Moreover, by using the polyimide film in combination with the inorganic particles having a smaller refractive index in the major axis direction than the average refractive index in the direction perpendicular to the major axis direction, the major axis of the inorganic particles is oriented in the direction in which the polymer chain of the polyimide is stretched or oriented. Therefore, a larger refractive index in the direction perpendicular to the major axis direction of the inorganic particles, can counter the retardation derived from the orientation of the polymer chain of the polyimide.

As a result, according to the present invention, a resin film with improved rigidity and flex resistance and reduced optical distortion can be provided. As just described, the polyimide film in which the molecular chain of the polyimide is densely oriented, further obtains excellent impact resistance. Such a polyimide film of the present invention can be made into a resin film having reduced optical distortion and both high rigidity and excellent flex resistance that leaves no folding tendency or trace, both of which are difficult for resin films to achieve.

Due to the above, the polyimide film of the present invention can be made into a resin film having impact resistance or flex resistance, having improved heat resistance and rigidity, being transparent, and having reduced optical distortion.

Hereinafter, the polyimide film of the present invention will be described in detail.

The polyimide film of the present invention is a polyimide film comprising the polyimide containing an aromatic ring and the above-specified inorganic particles, and having the above-specified characteristics. The polyimide film may further contain other components or other structures, as long as the effect of the present invention are not impaired.

### 1. Polyimide

A polyimide is obtained by reacting a tetracarboxylic acid component with a diamine component. It is preferable that polyamide acid is obtained by polymerization of the tetracarboxylic acid component and the diamine component and imidized. The polyamide acid may be imidized by thermal imidization or chemical imidization. The polyimide can be produced by a method using both thermal imidization and chemical imidization.

The polyimide used in the present invention is a polyimide containing an aromatic ring, and at least one of the tetracarboxylic acid component and the diamine component contains the aromatic ring.

As the tetracarboxylic acid component, a tetracarboxylic dianhydride is preferably used. As the tetracarboxylic dianhydride, examples include, but are not limited to, cyclohexanetetracarboxylic dianhydride, cyclopentanetetracarboxylic dianhydride, dicyclohexane-3,4,3′,4′-tetracarboxylic dianhydride, pyromellitic dianhydride, 3,3′,4,4′-benzophenonetetracarboxylic dianhydride, 2,2′,3,3′-benzophenonetetracarboxylic dianhydride, 3,3′,4,4′-biphenyltetracarboxylic dianhydride, 2,2′,3,3′-biphenyltetracarboxylic dianhydride, 2,2-bis(3,4-dicarboxyphenyl)propane dianhydride, 2,2-bis(2,3-dicarboxyphenyl)propane dianhydride, bis(3,4-dicarboxyphenyl)ether dianhydride, bis(3,4-dicarboxyphenyl)sulfone dianhydride, 1,1-bis(2,3-dicarboxyphenyl)ethane dianhydride, bis(2,3-dicarboxyphenyl)methane dianhydride, bis(3,4-dicarboxyphenyl)methane dianhydride, 2,2-bis(3,4-dicarboxyphenyl)-1,1,1,3,3,3-hexafluoropropane dianhydride, 2,2-bis(2,3-dicarboxyphenyl)-1,1,1,3,3,3-hexafluoropropane dianhydride, 1,3-bis[(3,4-dicarboxy)benzoyl]benzene dianhydride, 1,4-bis[(3,4-dicarboxy)benzoyl]benzene dianhydride, 2,2-bis{4-[4-(1,2-dicarboxy)phenoxy]phenyl}propane dianhydride, 2,2-bis{4-[3-(1,2-dicarboxy)phenoxy]phenyl}propane dianhydride, bis{4-[4-(1,2-dicarboxy)phenoxy]phenyl}ketone dianhydride, bis{4-[3-(1,2-dicarboxy)phenoxy]phenyl}ketone dianhydride, 4,4′-bis[4-(1,2-dicarboxy)phenoxy]biphenyl dianhydride, 4,4′-bis[3-(1,2-dicarboxy)phenoxy]biphenyl dianhydride, bis{4-[4-(1,2-dicarboxy)phenoxy]phenyl}ketone dianhydride, bis{4-[3-(1,2-dicarboxy)phenoxy]phenyl}ketone dianhydride, bis{4-[4-(1,2-dicarboxy)phenoxy]phenyl}sulfone dianhydride, bis{4-[3-(1,2-dicarboxy)phenoxy]phenyl}sulfone dianhydride, bis{4-[4-(1,2-dicarboxy)phenoxy]phenyl}sulfide dianhydride, bis{4-[3-(1,2-dicarboxy)phenoxy]phenyl}sulfide dianhydride, 4,4′-(hexafluoroisopropylidene)diphthalic anhydride, 3,4′-(hexafluoroisopropylidene)diphthalic anhydride, 3,3′-(hexafluoroisopropylidene)diphthalic anhydride, 2,3,6,7-naphthalenetetracarboxylic dianhydride, 1,4,5,8-naphthalenetetracarboxylic dianhydride, 1,2,5,6-naphthalenetetracarboxylic dianhydride, 1,2,3,4-benzenetetracarboxylic dianhydride, 3,4,9,10-perylenetetracarboxylic dianhydride, 2,3,6,7-anthracenetetracarboxylic dianhydride, and 1,2,7,8-phenanthrenetetracarboxylic dianhydride.

They may be used alone or in combination of two or more kinds.

As the diamine component, examples include, but are not limited to, p-phenylenediamine, m-phenylenediamine, o-phenylenediamine, 3,3′-diaminodiphenylether, 3,4′-diaminodiphenylether, 4,4′-diaminodiphenylether, 3,3′-diaminodiphenylsulfide, 3,4′-diaminodiphenylsulfide, 4,4′-diaminodiphenylsulfide, 3,3′-diaminodiphenylsulfone, 3,4′-diaminodiphenylsulfone, 4,4′-diaminodiphenylsulfone, 3,3′-diaminobenzophenone, 4,4′-diaminobenzophenone, 3,4′-diaminobenzophenone, 4,4′-diaminobenzanilide, 3,3′-diaminodiphenylmethane, 4,4′-diaminodiphenylmethane, 3,4′-diaminodiphenylmethane, 2,2-di(3-aminophenyl)propane, 2,2-di(4-aminophenyl)propane, 2-(3-aminophenyl)-2-(4-aminophenyl)propane, 2,2-di(3-aminophenyl)-1,1,1,3,3,3-hexafluoropropane, 2,2-di(4-aminophenyl)-1,1,1,3,3,3-hexafluoropropane, 2-(3-aminophenyl)-2-(4-aminophenyl)-1,1,1,3,3,3-hexafluoropropane, 1,1-di(3-aminophenyl)-1-phenylethane, 1,1-di(4-aminophenyl)-1-phenylethane, 1-(3-aminophenyl)-1-(4-aminophenyl)-1-phenylethane, 1,3-bis(3-aminophenoxy)benzene, 1,3-bis(4-aminophenoxy)benzene, 1,4-bis(3-aminophenoxy)benzene, 1,4-bis(4-aminophenoxy)benzene, 1,3-bis(3-aminobenzoyl)benzene, 1,3-bis(4-aminobenzoyl)benzene, 1,4-bis(3-aminobenzoyl)benzene, 1,4-bis(4-aminobenzoyl)benzene, 1,3-bis(3-amino-α,α-dimethylbenzyl)benzene, 1,3-bis(4-amino-α,α-dimethylbenzyl)benzene, 1,4-bis(3-amino-α,α-dimethylbenzyl)benzene, 1,4-bis(4-amino-α,α-dimethylbenzyl)benzene, 1,3-bis(3-amino-α,α-ditrifluoromethylbenzyl)benzene, 1,3-bis(4-amino-α,α-ditrifluoromethylbenzyl)benzene, 1,4-bis(4-amino-α,α-ditrifluoromethylbenzyl)benzene, 2,6-bis(3-aminophenoxy)benzonitrile, 2,6-bis(3-aminophenoxy)pyridine, N,N′-bis(4-aminophenyl)terephthalamide, 9,9-bis(4-aminophenyl)fluorene, 2,2′-dimethyl-4,4′-diaminobiphenyl, 2,2′-ditrifluoromethyl-4,4′-diaminobiphenyl, 3,3′-dichloro-4,4′-diaminobiphenyl, 3,3′-dimethoxy-4,4′-diaminobiphenyl, 3,3′-dimethyl-4,4′-diaminobiphenyl, 4,4′-bis(3-aminophenoxy)biphenyl, 4,4′-bis(4-aminophenoxy)biphenyl, bis[4-(3-aminophenoxy)phenyl]ketone, bis[4-(4-aminophenoxy)phenyl]ketone, bis[4-(3-aminophenoxy)phenyl]sulfide, bis[4-(4-aminophenoxy)phenyl]sulfide,

bis[4-(3-aminophenoxy)phenyl]sulfone, bis[4-(4-aminophenoxy)phenyl]sulfone, bis[4-(3-aminophenoxy)phenyl]ether, bis[4-(4-aminophenoxy)phenyl]ether, 2,2-bis[4-(3-aminophenoxy)phenyl]propane, 2,2-bis[4-(4-aminophenoxy)phenyl]propane, 2,2-bis[3-(3-aminophenoxy)phenyl]-1,1,1,3,3,3-hexafluoropropane, 2,2-bis[4-(4-aminophenoxy)phenyl]-1,1,1,3,3,3-hexafluoropropane, 1,3-bis[4-(3-aminophenoxy)benzoyl]benzene, 1,3-bis[4-(4-aminophenoxy)benzoyl]benzene, 1,4-bis[4-(3-aminophenoxy)benzoyl]benzene, 1,4-bis[4-(4-aminophenoxy)benzoyl]benzene, 1,3-bis[4-(3-aminophenoxy)-α,α-dimethylbenzyl]benzene, 1,3-bis[4-(4-aminophenoxy)-α,α-dimethylbenzyl]benzene, 1,4-bis[4-(3-aminophenoxy)-α,α-dimethylbenzyl]benzene, 1,4-bis[4-(4-aminophenoxy)-α,α-dimethylbenzyl]benzene, 4,4′-bis[4-(4-aminophenoxy)benzoyl]diphenyl ether, 4,4′-bis[4-(4-amino-α,α-dimethylbenzyl)phenoxy]benzophenone, 4,4′-bis[4-(4-amino-α,α-dimethylbenzyl)phenoxy]diphenylsulfone, 4,4′-bis[4-(4-aminophenoxy)phenoxy]diphenylsulfone, 3,3′-diamino-4,4′-diphenoxybenzophenone, 3,3′-diamino-4,4′-dibiphenoxybenzophenone, 3,3′-diamino-4-phenoxybenzophenone, 3,3′-diamino-4-biphenoxybenzophenone, 6,6′-bis(3-aminophenoxy)-3,3,3′,3′-tetramethyl-1,1′-spirobiindan, 6,6′-bis(4-aminophenoxy)-3,3,3′,3′-tetramethyl-1,1′-spirobiindan, 1,3-bis(3-aminopropyl)tetramethyldisiloxane, 1,3-bis(4-aminobutyl)tetramethyldisiloxane, α,ω-bis(3-aminopropyl)polydimethylsiloxane, α,ω-bis(3-aminobutyl)polydimethylsiloxane, bis(aminomethyl)ether, bis(2-aminoethyl)ether, bis(3-aminopropyl)ether, bis(2-aminomethoxy)ethyl]ether, bis[2-(2-aminoethoxy)ethyl]ether, bis[2-(3-aminopropoxy)ethyl]ether,

trans-cyclohexanediamine, trans-1,4-bismethylenecyclohexane diamine, 2,6-bis(aminomethyl)bicyclo[2,2,1]heptane, 2,5-bis(aminomethyl)bicyclo[2,2,1]heptane, and diamines obtained by substituting at least one hydrogen atom on an aromatic ring of each of the above-mentioned diamines with a substituent group selected from a fluoro group, a methyl group, a methoxy group, a trifluoromethyl group or a trifluoromethoxy group.

They may be used alone or in combination of two or more kinds.

From the viewpoint of increasing light transmittability and improving rigidity, the polyimide used in the present invention is preferably a polyimide containing an aromatic ring and at least one selected from the group consisting of (i) a fluorine atom, (ii) an aliphatic ring and (iii) a linking group that serves to cut electronic conjugation between aromatic rings. When the polyimide contains an aromatic ring, the orientation is increased, and the rigidity is improved. However, due to the absorption wavelength of the aromatic ring, the transmittance of the polyimide shows a tendency to decrease.

When the polyimide contains (i) a fluorine atom, electrons in the polyimide framework can enter a state where charge transfer is less likely to occur. Therefore, the light transmittability of the polyimide is increased.

When the polyimide contains (ii) an aliphatic ring, pi-electron conjugation in the polyimide framework is cut and, as a result, charge transfer in the framework can be inhibited. Therefore, the light transmittability of the polyimide is increased.

When the polyimide contains (iii) a linking group that serves to cut electronic conjugation between aromatic rings, pi-electron conjugation in the polyimide framework is cut and, as a result, charge transfer in the framework can be inhibited. Therefore, the light transmittability of the polyimide is increased. As the linking group that serves to cut electronic conjugation between aromatic rings, examples include, but are not limited to, an ether bond, a thioether bond, a carbonyl bond, a thiocarbonyl bond, an amide bond, a sulfonyl bond, a sulfinyl bond and a divalent linking group such as an alkylene group that may be substituted with fluorine.

The polyimide is particularly preferably a polyimide containing an aromatic ring and a fluorine atom, from the viewpoint of increasing light transmittability and improving rigidity.

For the content ratio of the fluorine atoms, the ratio (F/C) between the number of fluorine atoms (F) and the number of carbon atoms (C), which is obtained by measuring the polyimide surface by X-ray photoelectron spectroscopy, is preferably 0.01 or more, and more preferably 0.05 or more. On the other hand, when the content ratio of the fluorine atoms is too high, the original heat resistance of the polyimide may decrease. Therefore, the ratio (F/C) between the number of fluorine atoms (F) and the number of carbon atoms (C) is preferably 1 or less, and more preferably 0.8 or less.

The ratio measured by X-ray photoelectron spectroscopy (XPS) can be obtained from the values (atom %) of the fluorine and carbon atoms measured with the use of an X-ray photoelectron spectrometer (such as “THETA PROBE” manufactured by Thermo Scientific).

From the viewpoint of increasing light transmittability and improving rigidity, as the polyimide, a polyimide in which 70% or more of hydrogen atoms bound to carbon atoms contained in the polyimide, are hydrogen atoms directly bound to the aromatic ring, is preferably used. The percentage of (the number of) the hydrogen atoms directly bound to the aromatic ring among (the number of) all of the hydrogen atoms bound to the carbon atoms contained in the polyimide, is more preferably 80% or more, and still more preferably 85% or more.

Also, the polyimide in which 70% or more of the hydrogen atoms bound to the carbon atoms contained in the polyimide, are hydrogen atoms directly bound to the aromatic ring, is preferred from the following viewpoint: in this case, the polyimide shows small changes in optical properties, especially, total light transmittance and yellowness index (YI) value, even when it is subjected to a step of heating in air or stretching at, for example, 200° C. or more. It is presumed that in the case of the polyimide in which 70% or more of the hydrogen atoms bound to the carbon atoms contained in the polyimide, are hydrogen atoms directly bound to the aromatic ring, the polyimide has low reactivity with oxygen, and, therefore, the chemical structure of the polyimide is less likely to change. A polyimide film is, due to its high heat resistance, often used in devices that requires a working process involving heating. However, in the case of the polyimide in which 70% or more of the hydrogen atoms bound to the carbon atoms contained in the polyimide, are hydrogen atoms directly bound to the aromatic ring, it is not needed to carry out the post-processes in an inert atmosphere for maintaining transparency. Therefore, the polyimide has such an advantage that facility costs and costs required for atmosphere control can be reduced.

The percentage of (the number of) the hydrogen atoms directly bound to the aromatic ring among (the number of) all of the hydrogen atoms bound to the carbon atoms contained in the polyimide, can be obtained by measuring a decomposition product of the polyimide by high-performance liquid chromatography, a gas chromatography mass spectrometer and NMR. For example, a sample is decomposed in an alkaline aqueous solution or supercritical methanol, and a decomposition product thus obtained is separated by high-performance liquid chromatography. Each separated peak is qualitatively analyzed by a gas chromatography mass spectrometer and NMR, and quantitatively analyzed by the high-performance liquid chromatography, thereby obtaining the percentage of (the number of) the hydrogen atoms directly bound to the aromatic ring, among (the number of) all of the hydrogen atoms contained in the polyimide.

From the viewpoint of increasing light transmittability and improving rigidity, the polyimide used in the present invention preferably has at least one structure selected from the group consisting of structures represented by the following general formulae (1) and (3):

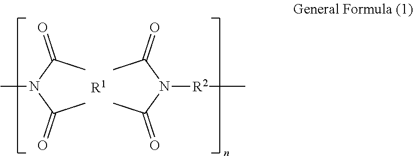

where R¹ represents a tetravalent group that is a tetracarboxylic acid residue; R² represents at least one divalent group selected from the group consisting of a trans-cyclohexanediamine residue, a trans-1,4-bismethylenecyclohexane diamine residue, a 4,4′-diaminodiphenylsulfone residue, a 3,4′-diaminodiphenylsulfone residue, and a divalent group represented by the following general formula (2); and n represents a number of repeating units and is 1 or more:

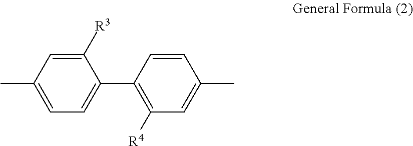

where R³ and R⁴ each independently represent a hydrogen atom, an alkyl group or a perfluoroalkyl group,

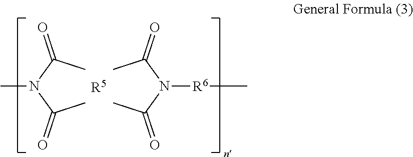

where R⁵ represents at least one tetravalent group selected from the group consisting of a cyclohexanetetracarboxylic acid residue, a cyclopentanetetracarboxylic acid residue, a dicyclohexane-3,4,3′,4′-tetracarboxylic acid residue, and a 4,4′-(hexafluoroisopropylidene)diphthalic acid residue; R⁶ represents a divalent group that is a diamine residue; and n′ represents a number of repeating units and is 1 or more.

The tetracarboxylic acid residue means a residue obtained by removing four carboxyl groups from tetracarboxylic acid, and it represents the same structure as a residue obtained by removing an acid dianhydride structure from tetracarboxylic dianhydride.

Also, the diamine residue means a residue obtained by removing two amino groups from diamine.

In the general formula (1), R¹ is a tetracarboxylic acid residue, and it can be a residue obtained by removing an acid dianhydride structure from the above-exemplified tetracarboxylic dianhydride.

Also in the general formula (1), from the viewpoint of increasing the light transmittability and improving the rigidity, it is preferable that R¹ contains at least one selected from the group consisting of a 4,4′-(hexafluoroisopropylidene)diphthalic acid residue, a 3,3′,4,4′-biphenyltetracarboxylic acid residue, a pyromellitic acid residue, a 2,3′,3,4′-biphenyltetracarboxylic acid residue, a 3,3′,4,4′-benzophenonetetracarboxylic acid residue, a 3,3′,4,4′-diphenylsulfonetetracarboxylic acid residue, a 4,4′-oxydiphthalic acid residue, a cyclohexanetetracarboxylic acid residue, and a cyclopentanetetracarboxylic acid residue. It is more preferable that R¹ contains at least one selected from the group consisting of a 4,4′-(hexafluoroisopropylidene)diphthalic acid residue, a 4,4′-oxydiphthalic acid residue and a 3,3′,4,4′-diphenylsulfonetetracarboxylic acid residue. The total content of the preferable residues in R¹ is preferably 50 mol % or more, more preferably 70 mol % or more, and still more preferably 90 mol % or more.

It is also preferable to use a mixture of a group of tetracarboxylic acid residues suited for improving rigidity (Group A) such as at least one selected from the group consisting of a 3,3′,4,4′-biphenyltetracarboxylic acid residue, a 3,3′,4,4′-benzophenonetetracarboxylic acid residue, and a pyromellitic acid residue, with a group of tetracarboxylic acid residues suited for increasing transparency (Group B) such as at least one selected from the group consisting of a 4,4′-(hexafluoroisopropylidene)diphthalic acid residue, a 2,3′,3,4′-biphenyltetracarboxylic acid residue, a 3,3′,4,4′-diphenylsulfonetetracarboxylic acid residue, a 4,4′-oxydiphthalic acid residue, a cyclohexanetetracarboxylic acid residue, and a cyclopentanetetracarboxylic acid residue. In this case, for the content ratio of the group of the tetracarboxylic acid residues suited for improving rigidity (Group A) and the group of the tetracarboxylic acid residues suited for increasing transparency (Group B), the group of the tetracarboxylic acid residues suited for improving rigidity (Group A) is preferably 0.05 mol or more and 9 mol or less, more preferably 0.1 mol or more and 5 mol or less, and still more preferably 0.3 mol or more and 4 mol or less, with respect to 1 mol of the group of the tetracarboxylic acid residues suited for increasing transparency (Group B).

Also in the general formula (1), from the viewpoint of increasing light transmittability and improving rigidity, R² is preferably at least one divalent group selected from the group consisting of a 4,4′-diaminodiphenylsulfone residue, a 3,4′-diaminodiphenylsulfone residue, and a divalent group represented by the general formula (2), and more preferably at least one divalent group selected from the group consisting of a 4,4′-diaminodiphenylsulfone residue, a 3,4′-diaminodiphenylsulfone residue, and a divalent group represented by the general formula (2) in which R³ and R⁴ are perfluoroalkyl groups.

In the general formula (3), R⁶ is a diamine residue, and it can be a residue obtained by removing two amino groups from the above-exemplified diamine.

Also in the general formula (3), from the viewpoint of increasing light transmittability and improving rigidity, it is preferable that R⁶ contains at least one divalent group selected from the group consisting of a 2,2′-bis(trifluoromethyl)benzidine residue, a bis[4-(4-aminophenoxy)phenyl]sulfone residue, a 4,4′-diaminodiphenylsulfone residue, a 2,2-bis[4-(4-aminophenoxy)phenyl]hexafluoropropane residue, a bis[4-(3-aminophenoxy)phenyl]sulfone residue, a 4,4′-diamino-2,2′-bis(trifluoromethyl)diphenyl ether residue, a 1,4-bis[4-amino-2-(trifluoromethyl)phenoxy]benzene residue, a 2,2-bis[4-(4-amino-2-trifluoromethylphenoxy)phenyl]hexafluoropropane residue, a 4,4′-diamino-2-(trifluoromethyl)diphenyl ether residue, a 4,4′-diaminobenzanilide residue, a N,N′-bis(4-aminophenyl)terephthalamide residue, and a 9,9-bis(4-aminophenyl)fluorene residue. It is more preferable that R⁶ contains at least one divalent group selected from the group consisting of a 2,2′-bis(trifluoromethyl)benzidine residue, a bis[4-(4-aminophenoxy)phenyl]sulfone residue, and a 4,4′-diaminodiphenylsulfone residue. The total content of the preferable residues in R⁶ is preferably 50 mol % or more, more preferably 70 mol % or more, and still more preferably 90 mol % or more.

It is also preferable to use a mixture of a group of diamine residues suited for improving rigidity (Group C) such as at least one selected from the group consisting of a bis[4-(4-aminophenoxy)phenyl]sulfone residue, a 4,4′-diaminobenzanilide residue, a N,N′-bis(4-aminophenyl) terephthalamide residue, a p-phenylenediamine residue, a m-phenylenediamine residue, and a 4,4′-diaminodiphenylmethane residue, and a group of diamine residues suited for increasing transparency (Group D) such as at least one selected from the group consisting of a 2,2′-bis(trifluoromethyl)benzidine residue, a 4,4′-diaminodiphenylsulfone residue, a 2,2-bis[4-(4-aminophenoxy)phenyl]hexafluoropropane residue, a bis[4-(3-aminophenoxy)phenyl]sulfone residue, a 4,4′-diamino-2,2′-bis(trifluoromethyl)diphenyl ether residue, a 1,4-bis[4-amino-2-(trifluoromethyl)phenoxy]benzene residue, a 2,2-bis[4-(4-amino-2-trifluoromethylphenoxy)phenyl]hexafluoropropane residue, a 4,4′-diamino-2-(trifluoromethyl)diphenyl ether residue, and a 9,9-bis(4-aminophenyl)fluorene residue. In this case, for the content ratio of the group of the diamine residues suited for improving rigidity (Group C) and the group of the diamine residues suited for increasing transparency (Group D), the group of the diamine residues suited for improving rigidity (Group C) is preferably 0.05 mol or more and 9 mol or less, more preferably 0.1 mol or more and 5 mol or less, and still more preferably 0.3 mol or more and 4 mol or less, with respect to 1 mol of the group of the diamine residues suited for increasing transparency (Group D).

Also in the general formula (3), from the viewpoint of increasing light transmittability and improving rigidity, it is preferable that R⁵ contains a 4,4′-(hexafluoroisopropylidene)diphthalic acid residue, a 3,3′,4,4′-diphenylsulfonetetracarboxylic acid residue, and an oxydiphthalic acid residue. The content of the preferable residues in R⁵ is preferably 50 mol % or more, more preferably 70 mol % or more, and still more preferably 90 mol % or more.

In the structures represented by the general formulae (1) and (3), n and n′ each independently represent a number of repeating units and are 1 or more.

The number (n) of the repeating units of the polyimide, is not particularly limited and may be appropriately selected depending on the structure so that the below-described preferable glass transition temperature is shown.

The average number of the repeating units is generally from 10 to 2000, and more preferably from 15 to 1000.

For the polyimide used in the present invention, a part thereof may contain a polyamide structure, as long as the effects of the present invention are not impaired. As the polyamide structure that may be contained, examples include, but are not limited to, a polyamideimide structure containing a tricarboxylic acid residue such as trimellitic anhydride, and a polyamide structure containing a dicarboxylic acid residue such as terephthalic acid.

For the polyimide used in the present invention, the glass transition temperature is preferably 250° C. or more, and more preferably 270° C. or more, from the viewpoint of heat resistance. On the other hand, the glass transition temperature is preferably 400° C. or less, and more preferably 380° C. or less, from the viewpoint of reduction in baking temperature and ease of stretching.

The glass transition temperature of the polyimide used in the present invention, can be measured in the same manner as the glass transition temperature of the below-described polyimide film.

### 2. Inorganic Particles

The inorganic particles used in the present invention are inorganic particles having a smaller refractive index in a major axis direction than an average refractive index in a direction perpendicular to the major axis direction. The inorganic particles used in the present invention are inorganic particles having shape anisotropy with major and minor axes. The major axis means the longest axis of the inorganic particles, and the minor axis means the shortest axis among axes perpendicular to the major axis. When the direction of the major axis, that of the minor axis and that of the axis perpendicular to both the major and minor axes are determined as a axis, b axis and c axis, respectively, the average refractive index in the direction perpendicular to the major axis direction represents the average value of refractive indices in the b-axis and c-axis directions.

For the inorganic particles, the aspect ratio of the major axis and the minor axis (the major axis/the minor axis) is preferably 1.5 or more, more preferably 2.0 or more, and still more preferably 3.0 or more. On the other hand, the aspect ratio of the inorganic particles is generally 1000 or less, and preferably 100 or less. The ratio between the axis perpendicular to both the major and minor axes and the minor axis (the axis perpendicular to both the major and minor axes/the minor axis) is preferably 1.0 or more and 1.5 or less, and more preferably 1.0 or more and 1.3 or less.

When the aspect ratio of the major axis and the minor axis (the major axis/the minor axis) is within such a range, the inorganic particles can be easily arranged in the orientation direction of the polyimide polymer chain in the polyimide film, and optical distortion of the polyimide film can be easily reduced.

From the viewpoint of increasing light transmittability, the average of the major axes of the inorganic particles (the average major axis) is preferably 500 nm or less, more preferably 400 nm or less, and still more preferably 350 nm or less. The average major axis can be measured by an electron micrograph. For example, for 100 particles observed by a transmission electron microscope, their major axes are measured, and the average is determined as the average major axis.

For the inorganic particles used in the present invention, the difference between the average refractive index in the direction perpendicular to the major axis direction and the refractive index in the major axis direction, is preferably 0.01 or more, more preferably 0.05 or more, and still more preferably 0.10 or more. When the refractive index difference is within such a range, the difference between the refractive index in the thickness direction of the polyimide film and the refractive index in the in-plane direction thereof, can be easily controlled while the light transmittability of the film is excellent.

The inorganic particles with such birefringence that the refractive index in the major axis direction is smaller than the average refractive index in the direction perpendicular to the major axis direction, may be particles composed of, as a main component, an inorganic compound that gives particles having a smaller refractive index in the major axis direction than the average refractive index in the direction perpendicular to the major axis direction. To form such inorganic particles, the inorganic compound that gives particles having a smaller refractive index in the major axis direction than the average refractive index in the direction perpendicular to the major axis direction, can be appropriately selected and used.

As the inorganic compound, examples include, but are not limited to, carbonates such as calcium carbonate, magnesium carbonate, zirconium carbonate, strontium carbonate, cobalt carbonate and manganese carbonate.

Of them, the inorganic compound is preferably at least one selected from the group consisting of calcium carbonate, magnesium carbonate, zirconium carbonate, strontium carbonate, cobalt carbonate and manganese carbonate, and particularly preferably strontium carbonate, from the following points of view: the birefringence is large; the optical distortion of the polyimide film can be reduced only by adding a small amount of the inorganic compound; and the light transmittability of the film can be easily increased.

To increase dispersibility and adhesion to the polyimide film, the inorganic particles may be surface-treated with a treatment agent such as a coupling agent.

As the surface treatment agent, a conventionally-known surface treatment agent can be appropriately selected and used, such as a silane-based surface treatment agent and a coupling agent. These surface treatment agents can be used alone or in combination of two or more kinds.

The content of the inorganic particles in the polyimide film is not particularly limited and may be appropriately controlled so that the birefringence index in the thickness direction of the polyimide film is 0.020 or less at a wavelength of 590 nm.

To obtain the birefringence index of 0.020 or less, the content of the inorganic particles is generally 0.01 mass % or more, and preferably 0.05 mass % or more, with respect to the total amount of the polyimide film.

On the other hand, when the content of the inorganic particles is too large, a decrease in light transmittability or other optical distortion may be caused. Therefore, the content of the inorganic particles is preferably 50 mass % or less, and more preferably 30 mass % or less, with respect to the total amount of the polyimide film.

The polyimide film may contain other components, as long as the effects of the present invention are not impaired. As such components, examples include, but are not limited to, a silica filler (for smooth winding) and a surfactant (for increasing film-forming and defoaming properties).

### 3. Properties of Polyimide Film

The size shrinkage ratio of the polyimide film of the first embodiment, the birefringence index and total light transmittance of the polyimide films of the first and second embodiments, and the linear thermal expansion coefficient of the polyimide film of the second embodiment, will not be described here since they are already described above.

As with the linear thermal expansion coefficient of the polyimide film of the second embodiment, the linear thermal expansion coefficient of the polyimide film of the first embodiment is preferably −10 ppm/° C. or more and 40 ppm/° C. or less, more preferably 20 ppm/° C. or less, and still more preferably 10 ppm/° C. or less.

It is preferable that the properties of polyimide film of the present invention are achieved when the thickness of the polyimide film is 200 μm or less, and it is more preferable that the properties are achieved when the thickness is 100 μm or less.

For the polyimide films of the first and second embodiments, the glass transition temperature is preferably 250° C. or more, and more preferably 270° C. or more, from the viewpoint of heat resistance. On the other hand, the glass transition temperature is preferably 400° C. or less, and more preferably 380° C. or less, from the viewpoint of reduction in baking temperature and ease of stretching.

The glass transition temperature is obtained from the peak temperature of tan δ (tan δ=loss elastic modulus (E″)/storage elastic modulus (E′)) by dynamic viscoelasticity measurement. The dynamic viscoelasticity measurement can be carried out by, for example, dynamic viscoelasticity measuring apparatus RSA III (product name, manufactured by TA Instruments Japan) in the conditions of a measurement range of from 25° C. to 400° C., a frequency of 1 Hz and a temperature increase rate of 5° C./min. Also, it can be measured in the conditions of a sample width of 5 mm and a chuck distance of 20 mm.

For the polyimide films of the first and second embodiments, the pencil hardness is preferably 2B or higher, more preferably B or higher, and still more preferably HB or higher, from the viewpoint of rigidity.

The pencil hardness of the polyimide film can be evaluated as follows. First, the humidity of an evaluation sample is controlled for two hours in the conditions of a temperature of 25° C. and a relative humidity of 60%. Then, using pencils defined in JIS-S-6006, the pencil hardness test defined in JIS K5600-5-4 (1999) is carried out on the film surface (at a load of 9.8 N), thereby evaluating the highest pencil hardness that leaves no scratch on the film surface. For example, a pencil scratch hardness tester manufactured by Toyo Seiki Seisaku-sho, Ltd., can be used.

For the polyimide films of the first and second embodiments, in accordance with the flex resistance test (cylindrical mandrel method) described in JIS K5600-5-1, the diameter of a mandrel at which the film begins to crack and fold, is preferably 5 mm or less, and more preferably 2 mm or less, from the viewpoint of flex resistance.

The flex resistance test can be carried out in accordance with JIS K5600-5-1 Type 1, and paint film bending tester No. 514 (manufacture by Yasuda Seiki Seisakusho, Ltd.) can be used. The evaluation sample may be a rectangular sample with a size of 100 mm×50 mm, for example. In the measurement, the humidity of the sample is controlled for two hours in the conditions of a temperature of 25° C. and a relative humidity of 60% before use.

For the polyimide films of the first and second embodiments, the haze value is preferably 10 or less, more preferably 8 or less, and still more preferably 5 or less, from the viewpoint of light transmittability. It is preferable that the haze value can be achieved when the thickness of the polyimide films is 10 μm or more and 80 μm or less.

The haze value can be measured by the method according to JIS K-7105. For example, it can be measured by haze meter HM150 manufactured by Murakami Color Research Laboratory Co., Ltd.

For the polyimide films of the first and second embodiments, the yellowness index (YI value) is preferably or less, more preferably 15 or less, and still more preferably 10 or less, from the viewpoint of light transmittability and inhibiting yellowing.

The YI value can be obtained by the method according to JIS K7105-1981 with the use of an UV-Vis-NIR spectrophotometer (such as “V-7100” manufactured by JASCO Corporation) using a 2-degree field of view and, as a light source, illuminant C according to JIS Z8701-1999.

As a preferable embodiment, the ratio (F/C) between the number of fluorine atoms (F) and the number of carbon atoms (C) on the film surface, which is measured by X-ray photoelectron spectroscopy of the polyimide film, is preferably 0.01 or more and 1 or less, and more preferably 0.05 or more and 0.8 or less.

The ratio (F/N) between the number of fluorine atoms (F) and the number of nitrogen atoms (N) on the film surface, which is measured by X-ray photoelectron spectroscopy of the polyimide film, is preferably 0.1 or more and 20 or less, and more preferably 0.5 or more and 15 or less.

The above ratios measured by X-ray photoelectron spectroscopy (XPS) can be obtained from the values (atom %) of the atoms measured with the use of an X-ray photoelectron spectrometer (such as “THETA PROBE” manufactured by Thermo Scientific).

### 4. Structure of Polyimide Film

The thickness of the polyimide film may be appropriately selected depending on the intended application. It is preferably 0.5 μm or more, and more preferably 1 μm or more. On the other hand, it preferably 200 μm or less, and more preferably 150 μm or less.

When the thickness is small, the polyimide film has low strength and is likely to rupture. When the thickness is large, a large difference is shown between the inner and outer diameters of the film when bent, and large load is applied to the film. Therefore, the flex resistance of the film may decrease.

The polyimide film may be subjected to a surface treatment such as a saponification treatment, a glow discharge treatment, a corona discharge treatment, an UV treatment and a flame treatment.

### 5. Intended Application of Polyimide Film

The intended application of the polyimide film of the present invention is not particularly limited. The polyimide film can be used as a substrate or member required to have rigidity, in place of conventional glass products such as a glass substrate.

For example, since the polyimide film of the present invention is excellent in rigidity and in flex resistance or impact resistance, as a display that can adapt to a curved surface, it can be suitably used in thin, bendable and flexible organic EL displays and flexible panels used in mobile terminals (such as a smart phone and a wristwatch type terminal), display devices installed inside cars, and wristwatches). Also, the polyimide film of the present invention can be applied to members for image display devices (such as a liquid crystal display device and an organic EL display device), members for touch panels, and members for solar panels (such as a flexible printed circuit board, a surface protection film and a substrate material), members for optical waveguides, and members relating to semiconductors.

### II. Method for Producing Polyimide Film

The method for producing the polyimide film of the first embodiment is a method for producing a polyimide film, comprising steps of:

preparing a polyimide precursor resin composition having a water content of 1000 ppm or less and comprising a polyimide precursor containing an aromatic ring, inorganic particles having a smaller refractive index in a major axis direction than an average refractive index in a direction perpendicular to the major axis direction, and an organic solvent (hereinafter, this step will be referred to as “polyimide precursor resin composition preparing step”),

forming a polyimide precursor resin coating film by applying the polyimide precursor resin composition to a support (hereinafter, this step will be referred to as “polyimide precursor resin coating film forming step”),

imidizing the polyimide precursor by heating (hereinafter, this step will be referred to as “imidizing step”) and

stretching at least one of the polyimide precursor resin coating film and an imidized coating film obtained by imidizing the polyimide precursor resin coating film (hereinafter, this step will be referred to as “stretching step”),

Wherein the polyimide film comprises a polyimide and inorganic particles having a smaller refractive index in a major axis direction than an average refractive index in a direction perpendicular to the major axis direction;

wherein, when the polyimide film is monotonically heated from 25° C. at 10° C./min, a size shrinkage ratio represented by the following formula in at least one direction is 0.1% or more at at least one temperature in a range of from 250° C. to 400° C.: size shrinkage ratio (%)=[{(size at 25° C.)−(size after heating)}/(size at 25° C.)]×100;

wherein a birefringence index in a thickness direction is 0.020 or less at a wavelength of 590 nm; and

wherein a total light transmittance measured in accordance with JIS K7361-1 is 80% or more at a thickness of 10 μm.

Also, the method for producing the polyimide film of the first embodiment is preferably a production method in which the polyimide precursor resin composition preparing step is the step of preparing a polyimide precursor resin composition comprising a polyimide precursor containing an aromatic ring, inorganic particles having a smaller refractive index in a major axis direction than an average refractive index in a direction perpendicular to the major axis direction, and an organic solvent containing a nitrogen atom.

The polyimide film comprising the polyimide and the inorganic particles having a smaller refractive index in the major axis direction than the average refractive index in the direction perpendicular to the major axis direction, and showing the above-specified size shrinkage ratio, the above-specified birefringence index and the above-specified total light transmittance, will not be described here since it is already described above.

Hereinafter, the steps will be described in detail.

### 1. Polyimide Precursor Resin Composition Preparing Step

The first polyimide precursor resin composition that is preferably used in the production of the polyimide film of the present invention, is a polyimide precursor resin composition having a water content of 1000 ppm or less and comprising a polyimide precursor containing an aromatic ring, inorganic particles having a smaller refractive index in a major axis direction than an average refractive index in a direction perpendicular to the major axis direction, and an organic solvent.

In the case of using a polyimide with poor solubility in solvent, there is a possibility that the inorganic particles cannot be dispersed or are insufficiently dispersed. Meanwhile, since the polyimide precursor has good solvent solubility, a uniform polyimide film with improved rigidity and flex resistance and reduced optical distortion, can be easily obtained by dispersing the inorganic particles well in the organic solvent, while dissolving the polyimide precursor therein.

When the water content of the polyimide precursor resin composition is large, the polyimide precursor is likely to decompose. In addition, the inorganic particles may be dissolved and may not function as a refractive index controlling component. Meanwhile, according to the present invention, by using the polyimide precursor resin composition having a water content of 1000 ppm or less, dissolution of the inorganic particles can be inhibited; the polyimide precursor resin composition can obtain excellent storage stability; and the productivity can be improved.

The water content of the polyimide precursor resin composition can be obtained by, for example, a Karl Fischer water content meter (such as moisture meter CA-200 manufactured by Mitsubishi Chemical Corporation).

The second polyimide precursor resin composition preferably used in the production of the polyimide film of the present invention, is a polyimide precursor resin composition comprising a polyimide precursor containing an aromatic ring, inorganic particles having a smaller refractive index in a major axis direction than an average refractive index in a direction perpendicular to the major axis direction, and an organic solvent containing a nitrogen atom.

When the polyimide precursor is polyamide acid, since polyamide acid is acidic, there is a possibility that the inorganic particles are easily dissolved to change the particle form. Meanwhile, according to the present invention, the polyamide acid is neutralized by containing the organic solvent containing a nitrogen atom. Therefore, dissolution of the inorganic particles can be inhibited; the polyimide precursor resin composition can obtain excellent storage stability; and the productivity can be improved.

It is particularly preferable to use a polyimide precursor resin composition having a water content of 1000 ppm or less and comprising an organic solvent containing a nitrogen atom.

The polyimide precursor used in the polyimide precursor resin composition of the present invention, is preferably polyamide acid obtained by polymerization of a tetracarboxylic acid component and a diamine component.

The tetracarboxylic acid component and the diamine component will not be described here, since they are the same as those described above under “1. Polyimide”.

From the viewpoint of increasing the light transmittability of the polyimide film and improving the rigidity thereof, as described above under “1. Polyimide”, the polyimide precursor used in the present invention is preferably a polyimide precursor containing an aromatic ring and at least one selected from the group consisting of (i) a fluorine atom, (ii) an aliphatic ring and (iii) a linking group that serves to cut electronic conjugation between aromatic rings.

From the viewpoint of increasing the light transmittability and improving the rigidity, the polyimide precursor used in the present invention is particularly preferably a polyimide precursor containing an aromatic ring and a fluorine atom.

For the content ratio of the fluorine atoms, the ratio (F/C) between the number of fluorine atoms (F) and the number of carbon atoms (C), which is obtained by producing a coating film of the polyimide precursor and measuring the surface of the polyimide precursor coating film by X-ray photoelectron spectrometer, is preferably 0.01 or more, and more preferably 0.05 or more. On the other hand, when the content ratio of the fluorine atoms is too high, heat resistance and so on may decrease. Therefore, the ratio (F/C) between the number of the fluorine atoms (F) and the number of the carbon atoms (C) is preferably 1 or less, and more preferably 0.8 or less.

The polyimide precursor coating film is produced as follows, for example: a solution of the polyimide precursor is applied onto glass, and the applied solvent is dried in a circulation oven at 120° C., thereby obtaining a coating film having a thickness of 3.5 μm. The measurement by X-ray photoelectron spectrometer (XPS) can be carried out in the same manner as the fluorine content ratio of the polyimide.

From the viewpoint of increasing the light transmittability and improving the rigidity, 70% or more of hydrogen atoms bound to carbon atoms contained in the polyimide precursor, are preferably hydrogen atoms directly bound to the aromatic ring. The percentage of (the number of) the hydrogen atoms directly bound to the aromatic ring among (the number of) all of the hydrogen atoms bound to the carbon atoms contained in the polyimide precursor, is more preferably 80% or more, and still more preferably 85% or more.

The percentage of (the number of) the hydrogen atoms directly bound to the aromatic ring among (the number of) all of the hydrogen atoms bound to the carbon atoms contained in the polyimide precursor, can be obtained by measuring a decomposition product of the polyimide precursor by high-performance liquid chromatography, a gas chromatography mass spectrometer and NMR, in the same manner as the decomposition product of the polyimide.

From the viewpoint of increasing the light transmittability and improving the rigidity, the polyimide precursor preferably has at least one structure selected from the group consisting of structures represented by the following general formulae (1′) and (3′):

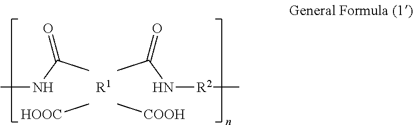

where R¹ represents a tetravalent group that is a tetracarboxylic acid residue; R² represents at least one divalent group selected from the group consisting of a trans-cyclohexanediamine residue, a trans-1,4-bismethylenecyclohexane diamine residue, a 4,4′-diaminodiphenylsulfone residue, a 3,4′-diaminodiphenylsulfone residue, and a divalent group represented by the following general formula (2); and n represents a number of repeating units and is 1 or more:

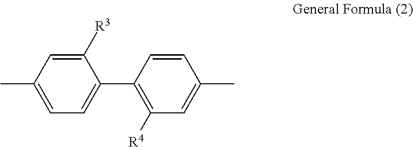

where R³ and R⁴ each independently represent a hydrogen atom, an alkyl group or a perfluoroalkyl group, and

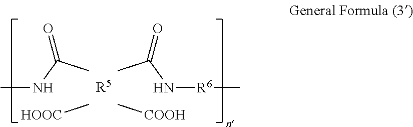

where R⁵ represents at least one tetravalent group selected from the group consisting of a cyclohexanetetracarboxylic acid residue, a cyclopentanetetracarboxylic acid residue, a dicyclohexane-3,4,3′,4′-tetracarboxylic acid residue, and a 4,4′-(hexafluoroisopropylidene)diphthalic acid residue; R⁶ represents a divalent group that is a diamine residue; and n′ represents a number of repeating units and is 1 or more.

As R¹ to R⁶ in the structures represented by the above general formulae (1′) and (3′), those described above under “1. Polyimide” can be preferably used.

The number average molecular weight of the polyimide precursor is preferably 2000 or more, and more preferably 4000 or more, from the viewpoint of the strength of the polyimide precursor formed into a film. On the other hand, the number average molecular weight is preferably 1000000 or less, and more preferably 500000 or less, from the point of view that the polyimide precursor may obtain high viscosity and low workability when the number average molecular weight is too large.

The number average molecular weight of the polyimide precursor can be obtained by NMR (such as “AVANCE III” manufactured by BRUKER). For example, a solution of the polyimide precursor is applied onto a glass plate and dried at 100° C. for 5 minutes; 10 mg of the dried solid content is dissolved in 7.5 ml of a dimethylsulfoxide-d6 solvent; the solution is subjected to NMR measurement; and the number average molecular weight can be calculated from the peak intensity ratio of the hydrogen atoms bound to the aromatic ring.

The polyimide precursor solution is obtained by reacting the above-mentioned tetracarboxylic dianhydride with the above-mentioned diamine in a solvent. The solvent used for synthesis of the polyimide precursor (polyamide acid) is not particularly limited, as long as it is a solvent that can dissolve the above-mentioned tetracarboxylic dianhydride and diamine. For example, an aprotic polar solvent and a water-soluble, alcohol-based solvent can be used. In the present invention, it is preferable to use γ-butyrolactone or an organic solvent containing a nitrogen atom, such as N-methyl-2-pyrrolidone, N,N-dimethylformamide, N,N-dimethylacetamide, dimethylsulfoxide, hexamethylphosphoramide and 1,3-dimethyl-2-imidazolidinone. In the case of using the polyamide acid solution as it is for preparing the polyimide precursor resin composition, from the viewpoint of inhibiting dissolution of the inorganic particles to be combined, it is preferable to use the organic solvent containing a nitrogen atom, and it is more preferable to use N,N-dimethylacetamide, N-methyl-2-pyrrolidone or a combination thereof. The organic solvent is a solvent containing a carbon atom.

When the molar number of the diamine in the solvent is determined as X and that of the tetracarboxylic dianhydride is determined as Y, Y/X is preferably 0.9 or more and 1.1 or less, more preferably 0.95 or more and 1.05 or less, still more preferably 0.97 or more and 1.03 or less, and most preferably 0.99 or more and 1.01 or less. When Y/X is within such a range, the molecular weight (polymerization degree) of the thus-obtained polyamide acid can be appropriately controlled.

The method of the polymerization reaction is not particularly limited and can be appropriately selected from conventional methods.

Also, the polyimide precursor solution obtained by the synthesis reaction may be used as it is and then mixed with other component, as needed. Or, the solvent of the polyimide precursor solution may be dried, dissolved in other solvent and used.

In the present invention, the viscosity of the polyimide precursor solution at a concentration of 15 weight % and 25° C., is preferably 500 cps or more and 100000 cps or less from the viewpoint of forming a uniform coating film and a uniform polyimide film.

The viscosity of the polyimide precursor solution can be measured by a viscometer (such as “TVE-22HT” manufactured by Toki Sangyo Co., Ltd.) at 25° C.

The inorganic particles used in the polyimide precursor resin composition of the present invention will not be described here, since the same inorganic particles as those described above under “I. Polyimide film” can be used.

The organic solvent used in the polyimide precursor resin composition of the present invention is not particularly limited, as long as it can dissolve the polyimide precursor and disperse the inorganic particles. For example, γ-butyrolactone and an organic solvent containing a nitrogen atom can be used, such as N-methyl-2-pyrrolidone, N,N-dimethylformamide, N,N-dimethylacetamide, dimethylsulfoxide, hexamethylphosphoramide and 1,3-dimethyl-2-imidazolidinone. Due to the above-described reason, it is preferable to use the organic solvent containing a nitrogen atom.

The polyimide precursor in the polyimide precursor resin composition is preferably 50 mass % or more of the solid content of the resin composition, and more preferably 60 mass % or more, from the viewpoint of forming a uniform coating film and a polyimide film with enough strength to handle the film. The upper limit is not particularly limited and may be appropriately controlled depending on the contained components. From the viewpoint of containing the inorganic particles, it is preferably 99.9 mass % or less, and more preferably 99.5 mass % or less.

The inorganic particles in the polyimide precursor resin composition of the present invention, are appropriately determined depending on the desired optical properties. From the viewpoint of controlling the optical properties, the inorganic particles are preferably 0.01 mass % or more of the solid content of the resin composition, and more preferably 0.05 mass % or more. On the other hand, it is preferably 50 mass % or less, and more preferably 40 mass % or less.

From the viewpoint of forming a uniform coating film and a uniform polyimide film, the organic solvent in the polyimide precursor resin composition of the present invention is preferably 40 mass % or more of the resin composition, and more preferably 50 mass % or more. On the other hand, it is preferably 99 mass % or less.

As the method for preparing the polyimide precursor resin composition of the present invention, examples include, but are not limited to, 1) dispersing the inorganic particles in the polyimide precursor solution and uniformizing the mixture, 2) mixing the polyimide precursor solution with the organic solvent in which the inorganic particles are dispersed, and uniformizing the mixture, and 3) dissolving the polyimide precursor in the organic solvent in which the inorganic particles are dispersed, and uniformizing the mixture.

As described above, to obtain the polyimide precursor resin composition having a water content of 1000 ppm or less, it is preferable to dry the inorganic particles in advance before use, or it is preferable to use a dehydrated organic solvent or an organic solvent with a controlled water content and handle the organic solvent in an environment at a humidity of 5% or less.

As the method for dispersing the inorganic particles in the organic solvent, conventionally known methods such as stirring and ultrasonic irradiation can be used. From the viewpoint of preventing water contamination, a dispersion method without the use of a medium such as inorganic beads is preferred, and a dispersion method by ultrasonic irradiation, vibration or the like is preferably used.

In the present invention, the viscosity of the polyimide precursor resin composition at a solid content concentration of 15 weight % and 25° C., is preferably 500 cps or more and 100000 cps or less from the viewpoint of forming a uniform coating film and a uniform polyimide film.

The viscosity of the polyimide precursor resin composition can be measured by a viscometer (such as “TVE-22HT” manufactured by Toki Sangyo Co., Ltd.) at 25° C., using a sample in an amount of 0.8 ml.

### 2. Polyimide Precursor Resin Coating Film Forming Step

This is a step of forming a polyimide precursor resin coating film by applying the polyimide precursor resin composition to a support.

The support is not particularly limited, as long as it is a material with a smooth surface, heat resistance and solvent resistance. As the support, examples include, but are not limited to, an inorganic material such as a glass plate, and a metal plate with a mirror polished surface. The form of the support is selected depending on the applying method. For example, it may be a plate form, a drum form, a belt form, or a sheet form that can be wound into a roll.

The applying method is not particularly limited, as long as it is a method that can apply the polyimide precursor resin composition to a desired thickness. For example, conventionally known devices such as a die coater, a comma coater, a roll coater, a gravure coater, a curtain coater, a spray coater and a lip coater, can be used.

The polyimide precursor resin composition can be applied by a sheet-fed coater, or it can be applied by a roll-to-roll coater.

After the polyimide precursor resin composition is applied to the support, the solvent in the coating film is dried at a temperature of 150° C. or less, preferably at a temperature of 30° C. or more and 120° C. or less, until the coating film becomes a tack-free coating film. By controlling the solvent drying temperature to 150° C. or less, imidization of the polyamide acid can be inhibited.

The drying time may be appropriately controlled, depending on the thickness of the polyimide precursor resin coating film, the type of the solvent, the drying temperature, etc. It is generally from 1 minute to 60 minutes, and preferably from 2 minutes to 30 minutes. It is not preferable to exceed the upper limit, from the viewpoint of production efficiency of the polyimide film. On the other hand, when the drying time is below the lower limit, rapid drying of the solvent may have adverse effects on the appearance and so on of the polyimide film thus obtained.

The method for drying the solvent is not particularly limited, as long as it is a method that can dry the solvent at the above temperature. For example, an oven, a drying furnace, a hot plate and infrared heating can be used.

When advanced control of the optical properties is necessary, the solvent is preferably dried in an inert gas atmosphere. The inert gas atmosphere is preferably a nitrogen atmosphere, and the oxygen concentration is preferably 100 ppm or less, and more preferably 50 ppm or less. When heated in air, the film is oxidized and may be colored or result in performance degradation.

### 3. Imidizing Step

In the production method, the polyimide precursor is imidized by heating.

The imidizing step may be carried out on the polyimide precursor in the polyimide precursor resin coating film before the below-described stretching step; it may be carried out on the polyimide precursor in the polyimide precursor resin coating film after the below-described stretching step; or it may be carried out on both the polyimide precursor in the polyimide precursor resin coating film before the stretching step and the polyimide precursor present in the film after the stretching step.

The imidizing temperature may be appropriately selected depending on the structure of the polyimide precursor.

In general, the heating start temperature is preferably 30° C. or more, and more preferably 100° C. or more. On the other hand, the heating end temperature is preferably 250° C. or more. Also, the heating end temperature is preferably 400° C. or less, and more preferably 360° C. or less.

It is preferable that the temperature increase rate is appropriately selected depending on the thickness of the polyimide film to be obtained. When the thickness of the polyimide film is thick, it is preferable to lower the temperature increase rate.

From the viewpoint of production efficiency of the polyimide film, the temperature increase rate is preferably 5° C./min or more, and more preferably 10° C./min or more. On the other hand, the upper limit of the temperature increase rate is generally 50° C./min, preferably 40° C./min or less, and still more preferably 30° C./min or less. It is preferable that the temperature increase rate is set as above, from the viewpoints of inhibiting defects in the appearance and strength of the film, controlling whitening associated with the imidization reaction, and increasing light transmittability.

The heating may be carried out continuously or in steps. It is preferably carried out continuously, from the viewpoint of inhibiting defects in the appearance and strength of the film, and controlling whitening associated with the imidization reaction. Also, the temperature increase rate may be constant in the above temperature range, or it may be changed in the middle.

For imidization, the heating is preferably carried out in an inert gas atmosphere. The inert gas atmosphere is preferably a nitrogen atmosphere, and the oxygen concentration is preferably 100 ppm or less, and more preferably 50 ppm or less. When heated in air, the film is oxidized and may be colored or result in performance degradation.

However, when 70% or more of the hydrogen atoms bound to the carbon atoms contained in the polyimide precursor, are hydrogen atoms directly bound to the aromatic ring, the effect of oxygen on the optical properties is small, and a polyimide with high light transmittability can be obtained without the use of the inert gas atmosphere.

The heating method for imidization is not particularly limited, as long as it is a method that allows heating at the above temperature. For example, an oven, a heating furnace, infrared heating and electromagnetic induction heating can be used.

It is preferable to control the imidization rate of the polyimide precursor to 50% or more before the stretching step. By controlling the imidization rate to 50% or more before the stretching step, poor film appearance and film whitening are inhibited even when the film is stretched after the controlling step and then heated for a certain amount of time at a high temperature for imidization. Especially from the viewpoint of improving the rigidity of the polyimide film, it is preferable to control the imidization rate to 80% or more, more preferably 90% or more, and still more preferably 100%, in the imidizing step and before the stretching step. By stretching the film after the imidization, the rigid polymer chain is easily oriented; therefore, it is presumed that the rigidity of the polyimide film is improved.

The imidization rate can be measured by IR spectral analysis, for example.

To obtain the final polyimide film, it is preferable to proceed with the imidization reaction until the imidization rate reaches 90% or more, 95% or more, or 100%.

To proceed with the imidization reaction until the imidization rate reaches 90% or more, or 100%, it is preferable that the coating film is kept at the heating end temperature for a certain amount of time. The temperature keeping time is generally from 1 minute to 180 minutes, and preferably from 5 minutes to 150 minutes.

### 4. Stretching Step

This is a step of stretching at least one of the polyimide precursor resin coating film and an imidized coating film obtained by imidizing the polyimide precursor resin coating film.

From the viewpoint of improving the rigidity of the polyimide film, it is preferable that the polyimide film production method of the present invention includes the step of stretching the imidized coating film.

In the polyimide film production method of the present invention, when the initial size of the film before stretching is determined as 100%, the step of stretching the film to 101% or more and 10000% or less, is preferably carried out while the film is heated at a temperature of 80° C. or more.

At the time of stretching, it is preferable that the heating temperature is in a range of plus or minus 50° C. of the glass transition temperature of the polyimide or polyimide precursor, and it is more preferable that the heating temperature is in a range of plus or minus 40° C. of the glass transition temperature. When the stretching temperature is too low, the film may not be deformed, and orientation may not be sufficiently induced. On the other hand, when the stretching temperature is too high, orientation obtained by the stretching may be relaxed due to the temperature, and sufficient orientation may not be obtained.

The stretching step may be carried out simultaneously with the imidizing step. From the viewpoint of improving the rigidity of the polyimide film, the imidized coating film is preferably stretched after the imidization rate reaches 80% or more, more preferably 90% or more, still more preferably 95% or more, and most preferably substantially 100%.

The polyimide film is preferably stretched at a magnification of 101% or more and 10000% or less, and more preferably 101% or more and 500% or less. By stretching the polyimide film in the range, the rigidity of the polyimide film thus obtained can be improved further.

At the time of stretching, the method for fixing the film is not particularly limited and is selected depending on the type and so on of a stretching device. Also, the stretching method is not particularly limited. For example, the film can be stretched with the use of a stretching device equipped with a carrier device (e.g., tenter), while passing the film through a heating furnace. The polyimide film may be stretched only in one direction (longitudinal or transverse stretching), or it may be stretched in two directions by simultaneous biaxial stretching, sequential biaxial stretching, diagonal stretching, etc.

### 5. Second Method for Producing the Polyimide Film of the First Embodiment

As the second method for producing the polyimide film of the first embodiment, there is provided a method for producing a polyimide film, comprising steps of:

preparing a polyimide resin composition having a water content of 1000 ppm or less and comprising a polyimide containing an aromatic ring, inorganic particles having a smaller refractive index in a major axis direction than an average refractive index in a direction perpendicular to the major axis direction, and an organic solvent (hereinafter, this step will be referred to as “polyimide resin composition preparing step”),

forming a polyimide resin coating film by applying the polyimide resin composition to a support (hereinafter, this step will be referred to as polyimide resin coating film forming step”) and

stretching the polyimide resin coating film (hereinafter, this step will be referred to as “stretching step”),

wherein the polyimide film comprises a polyimide and inorganic particles having a smaller refractive index in a major axis direction than an average refractive index in a direction perpendicular to the major axis direction;

wherein, when the polyimide film is monotonically heated from 25° C. at 10° C./min, a size shrinkage ratio represented by the following formula in at least one direction is 0.1% or more at at least one temperature in a range of from 250° C. to 400° C.: size shrinkage ratio (%)=[{(size at 25° C.)−(size after heating)}/(size at 25° C.)]×100;

wherein a birefringence index in a thickness direction is 0.020 or less at a wavelength of 590 nm; and

wherein a total light transmittance measured in accordance with JIS K7361-1 is 80% or more at a thickness of 10 μm.

When the polyimide containing an aromatic ring is dissolved well in the organic solvent, a polyimide resin composition in which the polyimide is dissolved in the organic solvent and the inorganic particles are dispersed therein, can be suitably used in place of the polyimide precursor resin composition.

This production method can be suitably used when the polyimide containing an aromatic ring has such solvent solubility that 5 mass % or more of the polyimide is dissolved in the organic solvent at 25° C.

In the polyimide resin composition preparing step, as the polyimide containing an aromatic ring, a polyimide with the above-mentioned solvent solubility can be selected from the same polyimides as those described above under “I. Polyimide film” and used. As the imidizing method, it is preferable to use chemical imidization in which a dehydration cyclization reaction of the polyimide precursor is carried out with the use of a chemical imidization agent, in place of heating and dehydrating. In the case of carrying out the chemical imidization, a known compound such as amine (e.g., pyridine, β-picolinic acid), carbodiimide (e.g., dicyclohexylcarbodiimide) and acid anhydride (e.g., acetic anhydride) may be used as a dehydration catalyst. The acid anhydride is not limited to acetic anhydride, and examples include, but are not limited to, propionic anhydride, n-butyric anhydride, benzoic anhydride and trifluoroacetic anhydride. Also, tertiary amine such as pyridine and β-picolinic acid may be used in combination with the acid anhydride.

In the polyimide resin composition preparing step, as the inorganic particles, the same inorganic particles as those described above under “I. Polyimide film” can be used.

In the polyimide resin composition preparing step, as the organic solvent, the same organic solvent as that described above under “1. Polyimide precursor resin composition preparing step” can be used.

As the method for controlling the water content to 1000 ppm or less, the same method as that described above under “1. Polyimide precursor resin composition preparing step” can be used.

In the polyimide resin coating film forming step, as the support and applying method, the same support and applying method as those described above under “2. Polyimide precursor resin coating film forming step” can be used.

In the polyimide resin coating film forming step, the drying temperature is preferably in a range of from 80° C. to 150° C., under normal pressure. Under reduced pressure, the drying temperature is preferably in a range of from 10° C. to 100° C.

As the step of stretching the polyimide resin coating film, the same step as that described above under “4. Stretching step” can be used.

### 6. Method for Producing the Polyimide Film of the Second Embodiment

As the method for producing the polyimide film of the second embodiment, there is provided a method for producing a polyimide film, comprising steps of:

preparing a polyimide precursor resin composition having a water content of 1000 ppm or less and comprising a polyimide precursor containing an aromatic ring, inorganic particles having a smaller refractive index in a major axis direction than an average refractive index in a direction perpendicular to the major axis direction, and an organic solvent,

forming a polyimide precursor resin coating film by applying the polyimide precursor resin composition to a support, and

imidizing the polyimide precursor by heating,

wherein the polyimide film comprises a polyimide containing an aromatic ring, and inorganic particles having a smaller refractive index in a major axis direction than an average refractive index in a direction perpendicular to the major axis direction,

wherein a linear thermal expansion coefficient is −10 ppm/° C. or more and 40 ppm/° C. or less;

wherein a birefringence index in a thickness direction is 0.020 or less at a wavelength of 590 nm;

wherein a total light transmittance measured in accordance with JIS K7361-1 is 80% or more at a thickness of 10 μm; and

wherein the polyimide has at least one structure selected from the group consisting of structures represented by the general formulae (1) and (3).

The method for producing the polyimide film of the second embodiment, may comprise a step of stretching at least one of the polyimide precursor resin coating film and an imidized coating film obtained by imidizing the polyimide precursor resin coating film.

The polyimide precursor resin composition preparing step can be carried out in the same manner as the method for producing the polyimide film of the first embodiment, as long as the polyimide precursor having at least one structure selected from the group consisting of structures represented by the general formulae (1′) and (3′), is used as an essential component.

The polyimide precursor resin coating film forming step and the polyimide precursor imidizing step can be carried out in the same manner as the method for producing the polyimide film of the first embodiment.

When the production method includes the step of stretching at least one of the polyimide precursor resin coating film and the imidized coating film obtained by imidizing the polyimide precursor resin coating film, they can be carried out in the same manner as the method for producing the polyimide film of the first embodiment.

### III. Polyimide Precursor Resin Composition

The polyimide precursor resin composition of the first embodiment of the present invention, is a polyimide precursor resin composition having a water content of 1000 ppm or less and comprising a polyimide precursor containing an aromatic ring, inorganic particles having a smaller refractive index in a major axis direction than an average refractive index in a direction perpendicular to the major axis direction, and an organic solvent.

The polyimide precursor resin composition of the first embodiment of the present invention, is a resin composition that is suitable for providing a polyimide film with improved rigidity and flex resistance and reduced optical distortion.

Since the polyimide precursor has excellent solvent solubility, a uniform polyimide film with improved rigidity and flex resistance and reduced optical distortion, can be easily obtained by dissolving the polyimide precursor in the organic solvent and dispersing the inorganic particles well.

When the water content of the polyimide precursor resin composition is large, the polyimide precursor is likely to decompose. In addition, the inorganic particles may be dissolved and may not function as a refractive index controlling component. However, by using the polyimide precursor resin composition of the present invention having a water content of 1000 ppm or less, dissolution of the inorganic particles can be inhibited; the polyimide precursor resin composition can obtain excellent storage stability; and the productivity can be improved.

The polyimide precursor resin composition of the second embodiment of the present invention, is a polyimide precursor resin composition comprising a polyimide precursor containing an aromatic ring, inorganic particles having a smaller refractive index in a major axis direction than an average refractive index in a direction perpendicular to the major axis direction, and an organic solvent containing a nitrogen atom.

When the polyimide precursor is polyamide acid, since polyamide acid is acidic, there is a possibility that the inorganic particles are easily dissolved to change the particle form. Meanwhile, according to the present invention, the polyamide acid is neutralized by containing the organic solvent containing a nitrogen atom. Therefore, dissolution of the inorganic particles can be inhibited; the polyimide precursor resin composition can obtain excellent storage stability; and the productivity can be improved.

The polyimide precursor resin composition is particularly preferably a polyimide precursor resin composition having a water content of 1000 ppm or less and comprising an organic solvent containing a nitrogen atom.

The components of the polyimide precursor resin composition of the present invention will not be described here, since they can be the same as those described above under “1. Polyimide precursor resin composition preparing step” of “II. Method for producing polyimide film”.

The present invention is not limited by the above-mentioned embodiments. The above-mentioned embodiments are examples, and any that has the substantially same essential features as the technical ideas described in claims of the present invention and exerts the same effects and advantages is included in the technical scope of the present invention.

### EXAMPLES

### [Evaluation Method]

### <Number Average Molecular Weight of Polyimide Precursor>

The number average molecular weight of a polyimide precursor was obtained by NMR (such as “AVANCE III” manufactured by BRUKER). More specifically, a solution of the polyimide precursor was applied onto a glass plate and dried at 100° C. for 5 minutes; 10 mg of the dried solid content was dissolved in 7.5 ml of a dimethylsulfoxide-d6 solvent; the solution was subjected to NMR measurement; and the number average molecular weight was calculated from the peak intensity ratio of the hydrogen atoms bound to the aromatic ring.

### <Viscosity of Polyimide Precursor Solution>

The viscosity of the polyimide precursor solution was measured by a viscometer (such as “TVE-22HT” manufactured by Toki Sangyo Co., Ltd.) at 25° C., using a sample in an amount of amount of 0.8 ml.

### <Total Light Transmittance>

The total light transmittance was measured by a haze meter (such as “HM150” manufactured by Murakami Color Research Laboratory Co., Ltd.) in accordance with JIS K7361-1. A corresponding value at a thickness of 10 μm was obtained by the Beer-Lambert law, as follows.

In particular, according to the Beer-Lambert law, a transmittance T is represented by Log₁₀(1/T)=kcb (where k=a substance-specific constant, c=concentration, b=optical path length).

In the case of the transmittance of a film, if it is assumed that the density is constant even when the thickness changes, c is a constant, too. Therefore, using a constant f, the above formula can be represented by Log₁₀(1/T)=fb (where f=kc). The constant f, which is specific to each substance, can be obtained if the transmittance of the film at a certain thickness is found. Therefore, the transmittance of the film at a desired thickness can be obtained by using the formula T= 1/10^{f·b} and plugging the obtained specific constant in f and a desired thickness in b.

### <YI Value>

The YI value was obtained by the method according to JIS K7105-1981 with the use of an UV-Vis-NIR spectrophotometer (such as “V-7100” manufactured by JASCO Corporation) using a 2-degree field of view and, as a light source, illuminant C according to JIS Z8701-1999.

### <Birefringence Index>

Using a retardation measurement device (product name: KOBRA-WR, manufactured by: Oji Scientific Instruments), the thickness-direction retardation value (Rth) of the polyimide film was measured at 23° C. by a light with a wavelength of 590 nm. The thickness-direction retardation value (Rth) was obtained as follows: the retardation value of incidence at an angle of 0 degrees and the retardation value of incidence at an oblique angle of degrees were measured, and the thickness-direction retardation value Rth was calculated from these retardation values. The retardation value of incidence at an oblique angle of 40 degrees was measured by making a light with a wavelength of 590 nm incident to a retardation film from a direction inclined at an angle of 40 degrees from the normal line of the retardation film.

The birefringence index of the polyimide film was obtained by plugging the obtained value in the following formula: Rth/d (where d is the thickness (nm) of the polyimide film).

### <Linear Thermal Expansion Coefficient and Size Shrinkage Ratio>

The linear thermal expansion coefficient was obtained as follows. Using a thermomechanical analyzer (such as “TMA-60” manufactured by Shimadzu Corporation), a change in the size of the polyimide film in a range of from 25° C. to 400° C., was measured at a temperature increasing rate of 10° C./min and a tensile load of 9 g/0.15 mm² so that the same load is applied per cross-sectional area of the evaluation sample. The linear thermal expansion coefficient was obtained by calculating a linear thermal expansion coefficient from results at 100° C. to 150° C. during the heating. It was measured in the conditions of a sample width of 5 mm and a chuck distance of 15 mm.

The size shrinkage ratio was obtained by calculating the ratio of the difference between the size of the sample at 25° C. and the size of the sample at each temperature in a temperature range of from 250° C. to 400° C., to the size of the sample at 25° C. (these sizes are those obtained in the above-mentioned linear thermal expansion coefficient measurement).

Size shrinkage ratio (%)=[{(size at 25° C.)−(size after heating)}/(size at 25° C.)]×100

### <Pencil Hardness>

Pencil hardness was evaluated as follows. First, the humidity of a measurement sample was controlled for two hours in the conditions of a temperature of 25° C. and a relative humidity of 60%. Then, using pencils defined in JIS-S-6006 and a pencil scratch hardness tester manufactured by Toyo Seiki Seisaku-sho, Ltd., the pencil hardness test defined in JIS K5600-5-4 (1999) was carried out on the surface of the sample film (at a load of 9.8 N), thereby evaluating the highest pencil hardness that left no scratch on the surface.

### <Flex Resistance>

Flex resistance was evaluated as follows. First, the humidity of a measurement sample (size: 100 mm×50 mm, rectangular) was controlled for two hours in the conditions of a temperature of 25° C. and a relative humidity of 60%. Then, using a paint film bending tester manufactured by Yasuda Seiki Seisakusho, Ltd., the flex resistance test defined in JIS K5600-5-1 Type 1 was carried out as follows, thereby evaluating the flex resistance of the measurement sample.

The tester was opened completely and equipped with a necessary mandrel. The measurement sample was held in the tester and bent. The sample was bent to an angle of 180° and kept at that angle for one to two seconds. After the bending was completed, the measurement sample was evaluated in the following manner, without removing the sample from the tester. In the evaluation, the measurement sample was examined by visual inspection and determined to be satisfactory when cracking and folding were not found thereon. On the other hand, the measurement sample was determined to be unsatisfactory when cracking and folding were found thereon.

With changing the mandrel to one having a smaller diameter, the evaluation was continued until the measurement sample caused cracking and folding. More specifically, the diameter of the mandrel that caused cracking and folding of the measurement sample for the first time, was recorded, and a mandrel diameter one size larger than that diameter was determined as flex resistance (bending diameter). The mandrel diameters used in the test were 2 mm, 3 mm, 4 mm, 5 mm, 6 mm, 8 mm, 10 mm, 12 mm, 16 mm, 20 mm, 25 mm and 32 mm.

### <Percentage of Hydrogen Atoms Directly Bound to Aromatic Ring Among Hydrogen Atoms Bound to Carbon Atoms Contained in Polyimide Film>

A pre-treatment was carried out as follows. In the pre-treatment, the polyimide film was decomposed in supercritical methanol to obtain a polyimide decomposition product. Overall qualitative analysis of the polyimide decomposition product was carried out by GC-MS. Next, the polyimide decomposition product was separated by high-performance liquid chromatography, peaks were collected each. Qualitative analysis of the collected fraction of each peak was carried out by a gas chromatography mass spectrometer and NMR. Using the high-performance liquid chromatography by which the qualitative analysis of the peaks was carried out, the percentage of the hydrogen atoms directly bound to the aromatic ring among the hydrogen atoms bound to the carbon atoms contained in the polyimide film, was quantitated.

### (1) Pre-Treatment

(i) The polyimide film was shaved with a knife to obtain polyimide film shavings. Next, as a sample polyimide film, 5 μg of the polyimide film shavings were put in a glass tube (“GLASS CAPSULE B” manufactured by FRONTIER LAB, outer diameter 2.5 mm).

(ii) Methanol (15 μl) was injected by a microsyringe into the glass tube containing the sample polyimide film.

(iii) The glass tube containing the sample polyimide film and the methanol, was sealed by a burner so as to have to a length of 25 mm or more and 34 mm or less.

(iv) The hermetically sealed glass tube was placed in an electric furnace at 280° C. and left for 10 hours.

(v) The glass tube was taken out from the electric furnace and opened.

### (2) Gas Chromatography Mass Spectrometry

GCMS device: GCMS2020 (product name, manufactured by Shimadzu Corporation)

Electric furnace: DOUBLE-SHOT PYROLYZER (manufactured by FRONTIER LAB)

Electric furnace temperature: 320° C.

Inlet temperature: 320° C.

Oven condition: Kept at 50° C. for 5 minutes, increased at 10° C./min, and then kept at 320° C. for 15 minutes

Interface temperature: 320° C.

Ion source temperature: 260° C.

Measured mass range (m/z): From 40 to 650

Column: ULTRA ALLOY-5 (or UA-5, length 30 m, inner diameter 0.25 mm, thickness 0.25 μm)

### (3) High-Performance Liquid Chromatography

Device: LC-20AD (low pressure gradient) SYSTEM (manufactured by Shimadzu Corporation)

Solvent: Mixed solvent (gradient mode) of acetonitrile and water

Flow rate: 0.2 ml/min

Column temperature: 40° C.

Detector: Photodiode array

Measured wavelength range: 200 nm to 400 nm

Injected sample amount: 1 μl

### (4) NMR

Device: AVANCE III (manufactured by BRUKER)

### Synthesis Example 1

First, 159 g of dehydrated N-methylpyrrolidone and 17 g of 2,2′-bis(trifluoromethyl)benzidine (TFMB) were put in a 500 ml separable flask and stirred at 25° C. with a mechanical stirrer. Then, 23 g of 4,4′-(hexafluoroisopropylidene)diphthalic anhydride (6FDA) was gradually added thereto, thereby synthesizing a polyimide precursor solution 1. The viscosity of the polyimide precursor solution 1 at a solid content of 20 mass % and 25° C., was 25900 cps. The number average molecular weight of the polyimide precursor was 130600.

### Synthesis Examples 2 to 8

Polyimide precursor solutions 2 to 8 were synthesized in the same manner as Synthesis Example 1, except that 17 g of 2,2′-bis(trifluoromethyl)benzidine (TFMB) and 4,4′-(hexafluoroisopropylidene)diphthalic anhydride (6FDA) were changed to equimolar amounts of diamine and acid dianhydride components shown in Table 1. Table 1 also shows the viscosities of the obtained polyimide precursor solutions at a solid content of 20 mass % and 25° C., and the number average molecular weights of the polyimide precursors.

### Synthesis Example 9

First, 166 g of dehydrated N-methylpyrrolidone and 12 g of trans-cyclohexanediamine (trans-CHE) were put in a 500 ml separable flask and dissolved by stirring at 25° C. with the mechanical stirrer. Then, 14 g of acetic acid dehydrated by a molecular sieve, was added thereto. Then, g of 3,3′,4,4′-biphenyltetracarboxylic dianhydride (BPDA) was gradually added thereto. After the addition was completed, the mixture was stirred at 25° C. for 12 hours, thereby synthesizing a polyimide precursor solution 9. Table 1 shows the viscosity of the obtained polyimide precursor solution at a solid content of 20 mass % and 25° C., and the number average molecular weight of the polyimide precursor.

TABLE 1

| | | | | Number |
|---|---|---|---|---|
| | | | | average |
| | | Acid | Viscosity | molecular |
| | Diamine | dianhydride | (cps) | weight |
| Polyimide | TFMB | 6FDA | 25900 | 130600 |
| precursor | | | | |
| solution 1 | | | | |
| Polyimide | TFMB | 6FDA:BPDA = | 24100 | 55000 |
| precursor | | 4:1 | | |
| solution 2 | | (molar ratio) | | |
| Polyimide | BAPS | 6FDA | 20100 | 159300 |
| precursor | | | | |
| solution 3 | | | | |
| Polyimide | BAPS-M | 6FDA | 16500 | 530900 |
| precursor | | | | |
| solution 4 | | | | |
| Polyimide | DDS | 6FDA | 5800 | 39900 |
| precursor | | | | |
| solution 5 | | | | |
| Polyimide | HFFAPP | 6FDA | 5000 | 199600 |
| precursor | | | | |
| solution 6 | | | | |
| Polyimide | DABA | 6FDA | 12300 | 61800 |
| precursor | | | | |
| solution 7 | | | | |
| Polyimide | AMC | BPDA | 228000 | 846300 |
| precursor | | | | |
| solution 8 | | | | |
| Polyimide | trans-CHE | BPDA | 6800 | 50100 |
| precursor | | | | |
| solution 9 | | | | |

The meaning of abbreviations shown in Table 1 are as follows.

### TFMB: 2,2′-Bis(trifluoromethyl)benzidine

BAPS: Bis[4-(4-aminophenoxy)phenyl]sulfone
BAPS-M: Bis[4-(3-aminophenoxy)phenyl]sulfone
DDS: 4,4′-diaminodiphenylsulfone
HFFAPP: 2,2-Bis[4-{4-amino-2-(trifluoromethyl)phenoxy}phenyl]hexafluoropropane

### DABA: 4,4′-Diaminobenzanilide

AMC: 1,4-Bis(aminomethyl)cyclohexane (cis- and trans-mixture)
trans-CHE: Trans-cyclohexanediamine
6FDA: 4,4′-(hexafluoroisopropylidene)diphthalic anhydride
BPDA: 3,3′,4,4′-biphenyltetracarboxylic dianhydride

### Reference Example 1: Evaluation of Polyimide Precursors

Polyimide films A to I having a thickness of 30 μm plus or minus 5 μm, were produced from the polyimide precursor solutions 1 to 9, respectively, by the following steps (1) to (3).

The step (2), which is an imidizing step, was carried out in nitrogen (oxygen concentration 50 ppm or less) and in air. The total light transmittances (%) of the produced films were compared (Table 2).

(1) The polyimide precursor solution was applied onto glass and dried in a circulation oven at 120° C. for 10 minutes.

(2) The dried sample was heated to 350° C. at a temperature increase rate of 10° C./min, kept at 350° C. for one hour, and then cooled down to room temperature.

(3) The polyimide film thus produced was removed from the glass.

TABLE 2

| | | | | Percentage (%) of hydrogen | | |
|---|---|---|---|---|---|---|
| | | | | atoms directly bound to | | |
| | Polyimide | | | aromatic ring among hydrogen | Total light transmittance (%) | |
| | precursor | | | atoms bound to carbon atoms | Atmosphere of | Atmosphere of |
| | solution | Diamine | Acid dianhydride | contained in polyimide film | Step (2) was nitrogen | Step (2) was air |
| Polyimide film A | 1 | TFMB | 6FDA | 100 | 90.8 | 90.5 |
| Polyimide film B | 2 | TFMB | 6FDA:BPDA = 4:1 | 100 | 90.6 | 90.0 |
| | | | (molar ratio) | | | |
| Polyimide film C | 3 | BAPS | 6FDA | 100 | 88.7 | 88.0 |
| Polyimide film D | 4 | BAPS-M | 6FDA | 100 | 87.5 | 87.4 |
| Polyimide film E | 5 | DDS | 6FDA | 100 | 90.6 | 90.6 |
| Polyimide film F | 6 | HFFAPP | 6FDA | 100 | 89.5 | 89.7 |
| Polyimide film G | 7 | DABA | 6FDA | 100 | 87.9 | 84.9 |
| Polyimide film H | 8 | AMC | BPDA | 33.3 | 88.2 | 3.5 |
| Polyimide film I | 9 | trans-CHE | BPDA | 37.5 | 82.7 | 61.3 |

By Reference Example 1, it was revealed that the polyimide precursor in which the percentage of the hydrogen atoms directly bound to the aromatic ring among the hydrogen atoms bound to the carbon atoms contained in the polyimide precursor, is higher, shows small changes in optical properties (especially total light transmittance) even when it is subjected to the imidizing step in air.

### Reference Example 2: Heat Resistance Evaluation of Polyimides

The polyimide films A to I having a thickness of 30 μm plus or minus 5 μm, which were produced above through the imidizing step (2) in which the atmosphere was nitrogen, were heated from room temperature to 300° C. at a temperature increase rate of 10° C./min in nitrogen (oxygen concentration 50 ppm or less) and in air. Then, they were heated at 300° C. for two hours and naturally cooled down to room temperature. The total light transmittances (%) of the samples were measured. The results are shown in Table 3.

TABLE 3

| | | Total light transmittance | |
|---|---|---|---|
| | Initial | (%) | |
| | total light | Atmosphere of post- | Atmosphere of |
| | transmittance | treatment was | post-treatment |
| | (%) | nitrogen | was air |
| Polyimide film A | 90.8 | 90.8 | 90.7 |
| Polyimide film B | 90.6 | 90.6 | 90.5 |
| Polyimide film C | 88.7 | 88.7 | 88.7 |
| Polyimide film D | 87.5 | 87.5 | 87.4 |
| Polyimide film E | 90.6 | 90.6 | 90.6 |
| Polyimide film F | 89.5 | 89.5 | 89.5 |
| Polyimide film G | 87.9 | 87.9 | 84.8 |
| Polyimide film H | 88.2 | 88.2 | 25.5 |
| Polyimide film I | 82.7 | 82.7 | 75.4 |

By Reference Example 2, it was revealed that the polyimide in which the percentage of the hydrogen atoms directly bound to the aromatic ring among the hydrogen atoms bound to the carbon atoms, is higher, shows small changes in optical properties (especially total light transmittance) even when it is heated in air in the post-process.

### Example 1

### (1) Preparation of Polyimide Precursor Resin Composition

Strontium carbonate particles that the average length of the major axis is 300 nm and the average length of the minor axis is 50 nm (manufactured by: Sakai Chemical Industry Co., Ltd., refractive index in the major axis direction: 1.52, average refractive index in a direction perpendicular to the major axis: 1.66) were added to the polyimide precursor solution 1 in a container so that the strontium carbonate particles was 0.7 mass % with respect to the solid content of a resin composition to be obtained. The container was hermetically closed and subjected to ultrasonic irradiation (by “USD-2R” manufactured by AS ONE Corporation) for three hours, thereby preparing a polyimide precursor resin composition 1-1 in which strontium carbonate was dispersed. The strontium carbonate particles were heated at 120° C. in advance and then added. The preparation of the polyimide precursor resin composition was carried out in a glove box kept at a humidity of 0%.

The water content of the obtained polyimide precursor resin composition 1-1 was measured with a Karl Fischer water content meter.

### (2) Production of Polyimide Film

The polyimide precursor resin composition 1-1 was applied onto glass and dried in a circulation oven at 120° C. for 10 minutes, thereby forming a polyimide precursor resin coating film. The resin coating film was heated to 350° C. at a temperature increase rate of 10° C./min in a nitrogen atmosphere (oxygen concentration 100 ppm or less), kept at 350° C. for one hour, naturally cooled down to room temperature, and then removed from the glass, thereby producing an imidized coating film 1-1 having a thickness of 37 mm.

The imidized coating film 1-1 was stretched the in the following conditions, thereby producing a polyimide film 1-1. As a result of examining various conditions, it was found that a range of plus or minus 10° C. of the glass transition temperature (340° C.) of the polyimide of the polyimide precursor 1, is preferred since the film stretching magnification can be increased.

Device: Film stretcher (model: IMC-1901, manufactured by: Imoto machinery Co., Ltd.)

Stretching Conditions

Sample size: 40 mm×40 mm (excluding chuck portions)

Heating temperature: 340° C. (in an air atmosphere)

Stretching rate: 10 mm/min

Time spent in chamber: 160 sec

Stretching magnification: 1.3 times

### Examples 2 and 4

The polyimide precursor resin composition 1-2 of Example 2 and the polyimide precursor resin composition 1-3 of Example 4 were prepared in the same manner as the preparation of the polyimide precursor resin composition of Example 1, except that the amount of the added strontium carbonate was changed as shown in Table 4. The water contents of the thus-obtained polyimide precursor resin compositions 1-2 and 1-3 were measured with the Karl Fischer moisture meter.

In the same manner as Example 1, polyimide films 1-2 and 1-3 were produced by using the polyimide precursor resin compositions 1-2 and 1-3, respectively.

TABLE 4

| | Amount of added strontium | |
|---|---|---|
| | carbonate | |
| | (with respect to solid content | Water content |
| | of resin composition) | (ppm) |
| Polyimide precursor resin | 0.7 mass % | 252 |
| composition 1-1 | | |
| Polyimide precursor resin | 0.9 mass % | 312 |
| composition 1-2 | | |
| Polyimide precursor resin | 1.1 mass % | 275 |
| composition 1-3 | | |

### Example 3

In the same manner as Example 2, an imidized coating film 1-2 was produced by using the polyimide precursor resin composition 1-2. A polyimide film 1-2N was produced in the same manner as Example 2, except that in the stretching step, the coating film was stretched at a heating temperature of 340° C. in a nitrogen atmosphere.

### Comparative Example 1

The polyimide film A not containing inorganic particles was stretched in the same manner as Example 1, thereby producing a comparative polyimide film A.

The thus-obtained polyimide films 1-1, 1-2, 1-2N and 1-3 of Examples 1 to 4 and the comparative polyimide film A of Comparative Example 1, were evaluated in terms of size shrinkage ratio, birefringence index, total light transmittance, YI value, linear thermal expansion coefficient, hardness, and flex resistance, by the above-mentioned evaluation methods. Table 5 shows the thickness, stretching magnification, stretching atmosphere, size shrinkage ratio, birefringence index, total light transmittance, YI value, linear thermal expansion coefficient, hardness, and flex resistance of the films.

TABLE 5

| | Amount | | | | Size | | | | Linear | | |
|---|---|---|---|---|---|---|---|---|---|---|---|
| | of added | | Stretching | | shrinkage | | Total light | | thermal | | |
| | inorganic | Thickness | magnification | Stretching | ratio (%) | Birefringence | transmittance | YI | expansion | Hard- | Flex |
| | particles | (μm) | (uniaxial) | atmosphere | at 370° C. | index | (%) | value | coefficient | ness | resistance |
| Example 1 | 0.7 | 34 | 1.3 | Air | 8.4 | 0.017 | 89.7 | 3.3 | 35 | HB | 2 mm |
| Example 2 | 0.9 | 34 | 1.3 | Air | 8.2 | 0.0007 | 89.5 | 3.3 | 33 | HB | 2 mm |
| Example 3 | 0.9 | 34 | 1.3 | Nitrogen | 8.1 | 0.0007 | 89.6 | 3.2 | 34 | HB | 2 mm |
| Example 4 | 1.1 | 34 | 1.3 | Air | 8.3 | 0.018 | 89.6 | 3.2 | 31 | HB | 2 mm |
| Comparative | 0 | 34 | 1.3 | Air | 9.7 | 0.08 | 90.5 | 2.3 | 31 | HB | 2 mm |
| Example 1 | | | | | | | | | | | |

1. A polyimide film comprising a polyimide containing an aromatic ring, and inorganic particles having a smaller refractive index in a major axis direction than an average refractive index in a direction perpendicular to the major axis direction,
wherein, when the polyimide film is monotonically heated from 25° C. at 10° C./min, a size shrinkage ratio represented by the following formula in at least one direction is 0.1% or more at at least one temperature in a range of from 250° C. to 400° C.: size shrinkage ratio (%)=[{(size at 25° C.)−(size after heating)}/(size at 25° C.)]×100;
wherein a birefringence index in a thickness direction is 0.020 or less at a wavelength of 590 nm; and
wherein a total light transmittance measured in accordance with JIS K7361-1 is 80% or more at a thickness of 10 μm.

2. The polyimide film according to claim 1, wherein the polyimide has at least one structure selected from the group consisting of structures represented by the following general formulae (1) and (3): 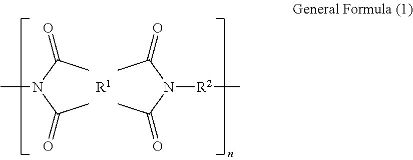
where R¹ represents a tetravalent group that is a tetracarboxylic acid residue; R² represents at least one divalent group selected from the group consisting of a trans-cyclohexanediamine residue, a trans-1,4-bismethylenecyclohexane diamine residue, a 4,4′-diaminodiphenylsulfone residue, a 3,4′-diaminodiphenylsulfone residue, and a divalent group represented by the following general formula (2); and n represents a number of repeating units and is 1 or more: 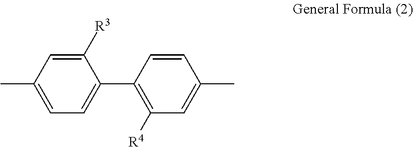
where R³ and R⁴ each independently represent a hydrogen atom, an alkyl group or a perfluoroalkyl group, 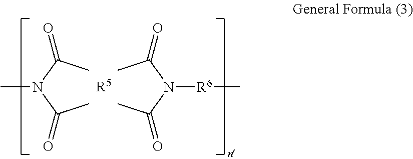
where R⁵ represents at least one tetravalent group selected from the group consisting of a cyclohexanetetracarboxylic acid residue, a cyclopentanetetracarboxylic acid residue, a dicyclohexane-3,4,3′,4′-tetracarboxylic acid residue, and a 4,4′-(hexafluoroisopropylidene)diphthalic acid residue; R⁶ represents a divalent group that is a diamine residue; and n′ represents a number of repeating units and is 1 or more.

3. The polyimide film according to claim 1, wherein 70% or more of hydrogen atoms bound to carbon atoms contained in the polyimide, are hydrogen atoms directly bound to the aromatic ring.

4. The polyimide film according to claim 1, wherein the inorganic particles are at least one kind of particles selected from the group consisting of calcium carbonate, magnesium carbonate, zirconium carbonate, strontium carbonate, cobalt carbonate and manganese carbonate.

5. A polyimide film comprising a polyimide containing an aromatic ring, and inorganic particles having a smaller refractive index in a major axis direction than an average refractive index in a direction perpendicular to the major axis direction,
wherein a linear thermal expansion coefficient is −10 ppm/° C. or more and 40 ppm/° C. or less;
wherein a birefringence index in a thickness direction is 0.020 or less at a wavelength of 590 nm;
wherein a total light transmittance measured in accordance with JIS K7361-1 is 80% or more at a thickness of 10 μm; and
wherein the polyimide has at least one structure selected from the group consisting of structures represented by the following general formulae (1) and (3): 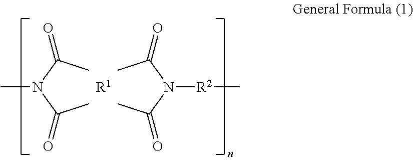
where R¹ represents a tetravalent group that is a tetracarboxylic acid residue; R² represents at least one divalent group selected from the group consisting of a trans-cyclohexanediamine residue, a trans-1,4-bismethylenecyclohexane diamine residue, a 4,4′-diaminodiphenylsulfone residue, a 3,4′-diaminodiphenylsulfone residue, and a divalent group represented by the following general formula (2); and n represents a number of repeating units and is 1 or more: 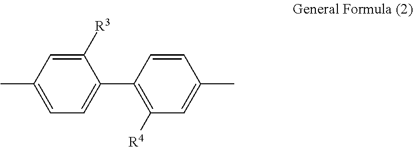
where R³ and R⁴ each independently represent a hydrogen atom, an alkyl group or a perfluoroalkyl group, and 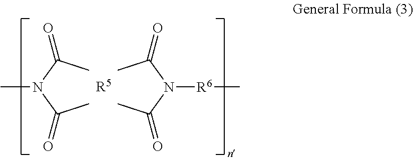
where R⁵ represents at least one tetravalent group selected from the group consisting of a cyclohexanetetracarboxylic acid residue, a cyclopentanetetracarboxylic acid residue, a dicyclohexane-3,4,3′,4′-tetracarboxylic acid residue, and a 4,4′-(hexafluoroisopropylidene)diphthalic acid residue; R⁶ represents a divalent group that is a diamine residue; and n′ represents a number of repeating units and is 1 or more.

6. The polyimide film according to claim 5, wherein 70% or more of hydrogen atoms bound to carbon atoms contained in the polyimide, are hydrogen atoms directly bound to the aromatic ring.

7. The polyimide film according to claim 5, wherein the inorganic particles are at least one kind of particles selected from the group consisting of calcium carbonate, magnesium carbonate, zirconium carbonate, strontium carbonate, cobalt carbonate and manganese carbonate.

8. A method for producing a polyimide film, comprising steps of: preparing a polyimide precursor resin composition having a water content of 1000 ppm or less and comprising a polyimide precursor containing an aromatic ring, inorganic particles having a smaller refractive index in a major axis direction than an average refractive index in a direction perpendicular to the major axis direction, and an organic solvent,
forming a polyimide precursor resin coating film by applying the polyimide precursor resin composition to a support,
imidizing the polyimide precursor by heating, and
stretching at least one of the polyimide precursor resin coating film and an imidized coating film obtained by imidizing the polyimide precursor resin coating film,
wherein the polyimide film comprises a polyimide and inorganic particles having a smaller refractive index in a major axis direction than an average refractive index in a direction perpendicular to the major axis direction;
wherein, when the polyimide film is monotonically heated from 25° C. at 10° C./min, a size shrinkage ratio represented by the following formula in at least one direction is 0.1% or more at at least one temperature in a range of from 250° C. to 400° C.: size shrinkage ratio (%)=[{(size at 25° C.)−(size after heating)}/(size at 25° C.)]×100;
wherein a birefringence index in a thickness direction is 0.020 or less at a wavelength of 590 nm; and
wherein a total light transmittance measured in accordance with JIS K7361-1 is 80% or more at a thickness of 10 μm.

9. The method for producing the polyimide film according to claim 8, the method comprising a step of stretching the imidized coating film obtained by imidizing the polyimide precursor resin coating film.

10. A polyimide precursor resin composition having a water content of 1000 ppm or less and comprising a polyimide precursor containing an aromatic ring, inorganic particles having a smaller refractive index in a major axis direction than an average refractive index in a direction perpendicular to the major axis direction, and an organic solvent.

11. A polyimide precursor resin composition comprising a polyimide precursor containing an aromatic ring, inorganic particles having a smaller refractive index in a major axis direction than an average refractive index in a direction perpendicular to the major axis direction, and an organic solvent containing a nitrogen atom.

12. The polyimide precursor resin composition according to claim 10, wherein the polyimide precursor has at least one structure selected from the group consisting of structures represented by the following general formulae (1′) and (3′): 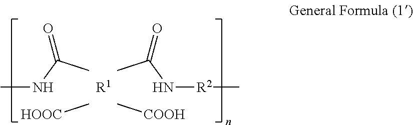
where R¹ represents a tetravalent group that is a tetracarboxylic acid residue; R² represents at least one divalent group selected from the group consisting of a trans-cyclohexanediamine residue, a trans-1,4-bismethylenecyclohexane diamine residue, a 4,4′-diaminodiphenylsulfone residue, a 3,4′-diaminodiphenylsulfone residue, and a divalent group represented by the following general formula (2); and n represents a number of repeating units and is 1 or more: 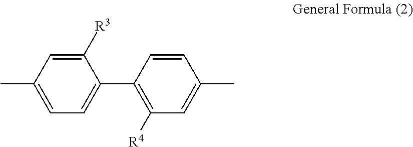
where R³ and R⁴ each independently represent a hydrogen atom, an alkyl group or a perfluoroalkyl group, and 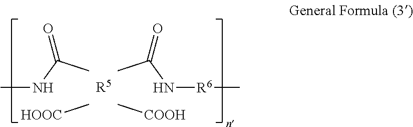
where R⁵ represents at least one tetravalent group selected from the group consisting of a cyclohexanetetracarboxylic acid residue, a cyclopentanetetracarboxylic acid residue, a dicyclohexane-3,4,3′,4′-tetracarboxylic acid residue, and a 4,4′-(hexafluoroisopropylidene)diphthalic acid residue; R⁶ represents a divalent group that is a diamine residue; and n′ represents a number of repeating units and is 1 or more.

13. The polyimide precursor resin composition according to claim 10, wherein 70% or more of hydrogen atoms bound to carbon atoms contained in the polyimide precursor, are hydrogen atoms directly bound to the aromatic ring.

14. The polyimide precursor resin composition according to claim 10, wherein the inorganic particles are at least one kind of particles selected from the group consisting of calcium carbonate, magnesium carbonate, zirconium carbonate, strontium carbonate, cobalt carbonate and manganese carbonate.

15. The polyimide precursor resin composition according to claim 11, wherein the polyimide precursor has at least one structure selected from the group consisting of structures represented by the following general formulae (1′) and (3′): 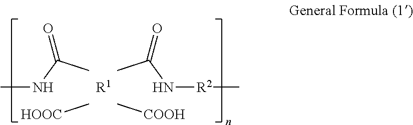
where R¹ represents a tetravalent group that is a tetracarboxylic acid residue; R² represents at least one divalent group selected from the group consisting of a trans-cyclohexanediamine residue, a trans-1,4-bismethylenecyclohexane diamine residue, a 4,4′-diaminodiphenylsulfone residue, a 3,4′-diaminodiphenylsulfone residue, and a divalent group represented by the following general formula (2); and n represents a number of repeating units and is 1 or more: 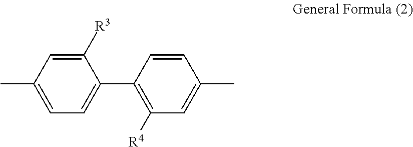
where R³ and R⁴ each independently represent a hydrogen atom, an alkyl group or a perfluoroalkyl group, and 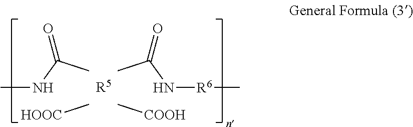
where R⁵ represents at least one tetravalent group selected from the group consisting of a cyclohexanetetracarboxylic acid residue, a cyclopentanetetracarboxylic acid residue, a dicyclohexane-3,4,3′,4′-tetracarboxylic acid residue, and a 4,4′-(hexafluoroisopropylidene)diphthalic acid residue; R⁶ represents a divalent group that is a diamine residue; and n′ represents a number of repeating units and is 1 or more.

16. The polyimide precursor resin composition according to claim 11, wherein 70% or more of hydrogen atoms bound to carbon atoms contained in the polyimide precursor, are hydrogen atoms directly bound to the aromatic ring.

17. The polyimide precursor resin composition according to claim 11, wherein the inorganic particles are at least one kind of particles selected from the group consisting of calcium carbonate, magnesium carbonate, zirconium carbonate, strontium carbonate, cobalt carbonate and manganese carbonate.
